(19) United States
(12) Patent Application Publication
(10) Pub. No.: US 2026/0239268 A1
(43) Pub. Date: Aug. 13, 2026

(54) ALIGNING DISCONTINUOUS RECEPTION (DRX) AND POSITIONING REFERENCE SIGNAL (PRS) OPERATIONS IN A WIRELESS NETWORK

(71) Applicant: Apple Inc., Cupertino, CA (US)

(72) Inventors: Alexander Sirotkin, Hod Hasharon (IL); Yuqin Chen, Beijing (CN); Ping-Heng Kuo, London (GB); Fangli Xu, Beijing (CN); Peng Cheng, Beijing (CN); Ralf Rossbach, Munich (DE); Sethuraman Gurumoorthy, San Ramon, CA (US); Naveen Kumar R. Venkata, San Diego, CA (US)

(21) Appl. No.: 19/149,635

(22) PCT Filed: Feb. 16, 2023
(86) PCT No.: PCT/CN2023/076509

§ 371 Date: Jul. 21, 2025

(51) Int. Cl. H04W 64/00; H04W 76/28

(52) U.S. Cl. CPC H04W 64/00; H04W 76/28

(57) ABSTRACT

Disclosed are methods, systems, and computer-readable medium to perform operations including transmitting, by a base station of a network, discontinuous reception (DRX) configuration data to a user equipment (UE) of the network, where the DRX configuration data specifies one or more parameters for performing DRX by the UE; receiving, by the base station from a location management function (LMF) of the network, a request for the DRX configuration data; and transmitting, by the base station, the DRX configuration data to the LMF.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In accordance with one aspect of the present disclosure, a method includes transmitting, by a base station of a network, discontinuous reception (DRX) configuration data to a user equipment (UE) of the network, where the DRX configuration data specifies one or more parameters for performing DRX by the UE; receiving, by the base station from a location management function (LMF) of the network, a request for the DRX configuration data; and transmitting, by the base station, the DRX configuration data to the LMF.

Implementations of this aspect can include one or more of the following features.

In some implementations, the request can be included in a POSITIONING INFORMATION REQUEST message transmitted to the base station by the LMF.

In some implementations, the DRX configuration data can be included in at least one of a POSITIONING INFORMATION RESPONSE message or a POSITIONING INFORMATION UPDATE MESSAGE transmitted by the base station to the LMF.

In some implementations, the request can signal the base station to transmit a single instance of the DRX configuration data to the LMF. Further, transmitting the DRX configuration data to the LMF can include transmitting the single instance of the DRX configuration data to the LMF.

In some implementations, the request can signal the base station to transmit the DRX configuration data to the LMF periodically until receipt of a second request signaling the base station to discontinue providing the DRX configuration data to the LMF. Further, transmitting the DRX configuration data to the LMF can include transmitting the DRX configuration data to the LMF periodically until receipt of the second request.

In some implementations, the DRX configuration data can include at least one of: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

In some implementations, the DRX configuration data can specify one or more parameters for performing DRX by the UE in a RRC_CONNECTED state.

In some implementations, the DRX configuration data can specify one or more parameters for performing Connected Mode DRX (C-DRX) by the UE.

In another aspect, a method includes: receiving, by a user equipment (UE) of a network, discontinuous reception (DRX) configuration data from a base station of the network, where the DRX configuration data specifies one or more parameters for performing DRX by the UE; receiving, by the UE, positioning reference signal (PRS) configuration data from a location management function (LMF) of the network, where the PRS configuration data specifies one or more parameters for obtaining one or more PRS measurements by the UE; performing, by the UE, DRX in accordance with the DRX configuration data, where performing DRX includes monitoring a Physical Downlink Control Channel (PDCCH) during one or more DRX ON durations determined based on the DRX configuration data; and obtaining, by the UE, the one or more PRS measurements in accordance with the PRS configuration data, where obtaining the one or more PRS measurements in accordance with the PRS configuration data includes obtaining the one or more PRS measurements during the one or more DRX ON durations.

Implementations of this aspect can include one or more of the following features.

In some implementations, the method can also include refraining from obtaining any PRS measurements during any DRX OFF durations.

In some implementations, the method can also include transmitting the one or more PRS measurements to the LMF.

In some implementations, the DRX configuration data can include at least one of: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

In some implementations, the DRX configuration data can specify one or more parameters for performing DRX by the UE in a RRC_CONNECTED state.

In some implementations, the DRX configuration data can specify one or more parameters for performing Connected Mode DRX (C-DRX) by the UE.

In another aspect, a method includes receiving, by a user equipment (UE) of a network, discontinuous reception (DRX) configuration data from a base station of the network, where the DRX configuration data specifies one or more parameters for performing DRX by the UE; transmitting, by the UE, the DRX configuration data to a location management function (LMF) of the network; receiving, by the UE, positioning reference signal (PRS) configuration data from the LMF, where the PRS configuration data specifies one or more parameters for obtaining one or more PRS measurements by the UE; performing, by the UE, DRX in accordance with the DRX configuration data, where performing DRX includes monitoring a Physical Downlink Control Channel (PDCCH) during one or more DRX ON durations determined based on the DRX configuration data; and obtaining, by the UE, the one or more PRS measurements in accordance with the PRS configuration data, where obtaining the one or more PRS measurements in accordance with the PRS configuration data includes obtaining the one or more PRS measurements during the one or more DRX ON durations.

In some implementations, the DRX configuration data can be included in an LTE Position Protocol (LPP) message transmitted by the UE to the LMF.

In some implementations, the method can also include refraining from obtaining any PRS measurements during any DRX OFF durations.

In some implementations, the method can also include transmitting the one or more PRS measurements to the LMF.

In some implementations, the DRX configuration data can include at least one of: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

In some implementations, the DRX configuration data can specify one or more parameters for performing DRX by the UE in a RRC_CONNECTED state.

In some implementations, the DRX configuration data can specify one or more parameters for performing Connected Mode DRX (C-DRX) by the UE.

In another aspect, a method includes: receiving, by a user equipment (UE) of a network, discontinuous reception (DRX) configuration data from a base station of the network, where the DRX configuration data specifies one or more parameters for performing DRX by the UE; performing, by the UE, DRX in accordance with the DRX configuration data, where performing DRX includes monitoring a Physical Downlink Control Channel (PDCCH) during one or more DRX ON durations determined based on the DRX configuration data; and obtaining, by the UE, one or more positioning reference signal (PRS) measurements during the one or more DRX ON durations.

Implementations of this aspect can include one or more of the following features.

In some implementations, the method can further include refraining from obtaining any PRS measurements during any DRX OFF durations.

In some implementations, the method can further in clude transmitting the one or more PRS measurements to a location management function (LMF) of the network.

In some implementations, the DRX configuration data can include at least one of: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

In some implementations, the DRX configuration data can specify one or more parameters for performing DRX by the UE in a RRC_CONNECTED state.

In some implementations, the DRX configuration data can specify one or more parameters for performing Connected Mode DRX (C-DRX) by the UE.

In another aspect, a method includes transmitting, by a base station of a network, discontinuous reception (DRX) configuration data to a user equipment (UE) of the network, where the DRX configuration data specifies one or more parameters for performing DRX by the UE; and transmitting, by the base station, control information to the UE, where the control information includes at least one of: an indication to obtain one or more positioning reference signal (PRS) measurements during a DRX ON duration, or an indication to refrain from obtaining any PRS measurements during a DRX OFF duration.

Implementations of this aspect can include one or more of the following features.

In some implementations, the control information can be transmitted to the UE via Medium Access Control (MAC) signaling.

In some implementations, the control information can be transmitted to the UE via Downlink Control Information (DCI) signaling.

In some implementations, the DRX configuration data can include at least one of: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

In some implementations, the DRX configuration data can specify one or more parameters for performing DRX by the UE in a RRC_CONNECTED state.

In some implementations, the DRX configuration data can specify one or more parameters for performing Connected Mode DRX (C-DRX) by the UE.

In another aspect, a method includes: receiving, by a user equipment (UE) of a network, discontinuous reception (DRX) configuration data from a base station of the network, where the DRX configuration data specifies one or more parameters for performing DRX by the UE; performing DRX in accordance with the DRX configuration data, where performing DRX includes monitoring a Physical Downlink Control Channel (PDCCH) during one or more DRX ON durations determined based on the DRX configuration data; receiving, by the UE, control information from the base station the UE, where the control information includes at least one of: an indication to obtain one or more positioning reference signal (PRS) measurements during one or more DRX ON durations, or an indication to refrain from obtaining any PRS measurements during any DRX OFF durations; and obtaining, by the UE, one or more PRS measurements in accordance with the control information.

Implementations of this aspect can include one or more of the following features.

In some implementations, the method can also include transmitting the one or more PRS measurements to a location management function (LMF) of the network.

In some implementations, the control information can be received from the base station via Medium Access Control (MAC) signaling.

In some implementations, the control information can be received from the base station via Downlink Control Information (DCI) signaling.

In some implementations, the DRX configuration data can include at least one of: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

In some implementations, the DRX configuration data can specify one or more parameters for performing DRX by the UE in a RRC_CONNECTED state.

In some implementations, the DRX configuration data can specify one or more parameters for performing Connected Mode DRX (C-DRX) by the UE.

In another aspect, a method includes: transmitting, by a base station of a network, discontinuous reception (DRX) configuration data to one or more user equipment (UEs) in a wireless cell of the network, where the DRX configuration data specifies one or more parameters for performing paging DRX by the one or more UEs with respect to the wireless cell, and where the DRX configuration data is specific to the wireless cell; receiving, by the base station from a location management function (LMF) of the network, a request for the DRX configuration data; and transmitting, by the base station, the DRX configuration data to the LMF.

Implementations of this aspect can include one or more of the following features.

In some implementations, the request can be included in a TRP INFORMATION REQUEST message transmitted to the base station by the LMF.

In some implementations, the DRX configuration data can be included in at least one of a TRP POSITIONING INFORMATION RESPONSE message or a TRP POSITIONING INFORMATION UPDATE MESSAGE transmitted by the base station to the LMF.

In some implementations, the request can signal the base station to transmit a single instance of the DRX configuration data to the LMF. Further, transmitting the DRX configuration data to the LMF can include transmitting the single instance of the DRX configuration data to the LMF.

In some implementations, the request can signal the base station to transmit the DRX configuration data to the LMF periodically until receipt of a second request signaling the base station to discontinue providing the DRX configuration data to the LMF. Further, transmitting the DRX configuration data to the LMF can include transmitting the DRX configuration data to the LMF periodically until receipt of the second request.

In some implementations, the DRX configuration data can include an information element representing a paging occasion configuration.

In some implementations, the DRX configuration data can specify one or more parameters for performing DRX by the one or more UEs in a RRC_INACTIVE or RRC_IDLE state.

In another aspect, a method includes: receiving, by a user equipment (UE) in a wireless cell of a network, discontinuous reception (DRX) configuration data from a base station of the network, where the DRX configuration data specifies one or more parameters for performing paging DRX with respect to the wireless cell of the network, and where the DRX configuration data is specific to the wireless cell; receiving, by the UE, positioning reference signal (PRS) configuration data from a location management function (LMF) of the network, where the PRS configuration data specifies one or more parameters for obtaining one or more PRS measurements by the UE; performing, by the UE, DRX in accordance with the DRX configuration data, where performing DRX includes monitoring a Physical Downlink Control Channel (PDCCH) during one or more DRX paging occasions determined based on the DRX configuration data; and obtaining, by the UE, one or more PRS measurements in accordance with the PRS configuration data, where obtaining the one or more PRS measurements in accordance with the PRS configuration data includes obtaining the one or more PRS measurements during the one or more DRX paging occasions.

Implementations of this aspect can include one or more of the following features.

In some implementations, the method can further include refraining from obtaining any PRS measurements during any paging occasions.

In some implementations, the method can further include transmitting the one or more PRS measurements to the LMF.

In some implementations, the DRX configuration data can include an information element representing a paging occasion configuration.

In some implementations, the DRX configuration data can specify one or more parameters for performing DRX by the UE in a RRC_INACTIVE or RRC_IDLE state.

In another aspect, a method includes: receiving, by a location management function (LMF) of a network, discontinuous reception (DRX) configuration data regarding one or more user equipment (UEs) of the network, where the DRX configuration data specifies one or more parameters for performing DRX by the one or more UE.

Implementations of this aspect can include one or more of the following features.

In some implementations, the DRX configuration data can include at least one of: an information element representing a DRX ON duration timer with respect to the one or more UE, an information element representing a DRX inactivity timer with respect to the one or more UEs, an information element representing a DRX slot offset with respect to the one or more UEs, an information element representing a short DRX cycle with respect to the one or more UEs, an information element representing a long DRX cycle with respect to the one or more UEs, or an information element representing a paging occasion configuration.

In some implementations, the method can further include generating, by the LMF, positioning reference signal (PRS) configuration data based on the DRX configuration data, where the PRS configuration data specifies one or more parameters for obtaining one or more PRS measurements by the one or more UEs.

In some implementations, the method can further include causing the PRS configuration data to be transmitted to the one or more UEs.

In some implementations, the method can further include receiving the one or more PRS measurements by the one or more UEs, and determining one or more locations of the one or more UEs based on the one or more PRS measurements.

In some implementations, at least a portion of the DRX configuration data can be received from the base station.

In some implementations, at least a portion of the DRX configuration data can be received from the one or more UE.

In another aspect, an apparatus includes one or more baseband processors configured to perform any of the operations described herein.

In another aspect, a method includes any of the any of the operations described herein.

In another aspect, an apparatus includes one or more baseband processors configured to perform any of the operations(s) described herein.

In another aspect, a system includes one or processors and one or more storage devices on which are stored instructions that are operable, when executed by the one or more processors, to cause the one or more processors to perform any of the operations(s) described herein.

In another aspect, a non-transitory computer storage medium is encoded with instructions that, when executed by one or more processors, cause the one or more processors to perform any of the operations(s) described herein.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network.

FIGS. 2-6 illustrates example processes for aligning DRX and PRS operations in a network.

FIGS. 7A-7I illustrate flowcharts of example methods.

FIG. 8 illustrates an example UE.

FIG. 9 illustrates an example access node.

### DETAILED DESCRIPTION

This disclosure sets forth various techniques for aligning Discontinuous Reception (DRX) and Positioning Reference Signal (PRS) operations in a wireless network, such as a cellular network.

In general, a user equipment (UE) can operate according to a DRX process, whereby the UE does not continuously monitor for paging messages from the network (e.g., paging messages transmitted by a base station of the network).

As an example, in Idle Mode DRX (also known as “Paging DRX”), the UE periodically monitors for paging messages the physical downlink control channel (PDCCH) while in a RRC_IDLE state (e.g., periodically according to one or more paging occasions). If the UE receives a paging message intended for the UE, the UE can transition to a RRC_CONNECTED state and receive downlink data in accordance with the paging message. However, if the UE does not receive a paging message intended for the UE, the UE can remain in the RRC_IDLE state.

As another example, in Connected Mode DRX (C-DRX), the periodically UE monitors the paging messages in the RRC_CONNECTED state. For instance, during periods of inactivity, the UE can enter a reduced power “sleep state” (e.g., during a C-DRX “Off” duration) during which the UE is not required to monitor the PDCCH for paging messages. Further, the UE can periodically enter a higher power “wake state” (e.g., during a C-DRX “On” duration) to monitor the PDCCH for paging messages, such as when the UE is required by the network to receive a downlink resource allocation. If the UE receives a paging message intended for the UE, the UE can receive downlink data in accordance with the paging message. Further, the UE may be permitted by the network to interrupt its sleep state to send a Scheduling Request and thus initiate uplink data transfer. The UE's behavior according to C-DRX can be configured by the network (e.g., based on DRX configuration data transmitted by the base station to the UE).

Further, a network can determine the location of certain devices of a network (e.g., one or more UEs) using a Positioning Reference Signal (PRS). A PRS is a downlink reference signal that, when measured by a receiving device, enables the network to determine the position of the receiving device relative to the transmitting device. For example, a UE can obtain measurements of one or more PRSes transmitted by a base station, and provide the PRS measurements to a network entity (e.g., a Locational Management Function, LMF). The network entity can determine the location of the UE based on these measurements, for instance by using positioning techniques such as roundtrip time (RTT), angle of arrival/departure (AoA/AoD), and/or time difference of arrival (TDOA).

To improve the efficiency of the network and its devices, DRX and PRS operations can be “aligned” with one another, such that the UE obtains PRS measurements during the same periods of time in which the UE is also monitoring for paging messages (e.g., during the C-DRX “On” duration), and refrains from obtaining measurements when the UE is not monitoring for paging messages (e.g., during the C-DRX “Off” duration). This can be beneficial, for example, in enabling the UE to obtain PRS measurements during time periods in which it is otherwise awake, instead of waking the UE specifically for this purposely. According, the UE can operate in a more power efficient manner.

In some implementations, DRX and PRS operations can be aligned through the use of signaling between the UE, base station, and/or other network entities (e.g., an LMF). As an example, DRX and PRS operations can be aligned based at least in part on LTE positioning protocol (LPP) (e.g., to transmit configuration data regarding DRX operations from a UE to an LMF). As another example, DRX and PRS operations can be aligned based at least in part on NR Positioning Protocol A (NRPPa) signaling (e.g., to transmit configuration data regarding DRX operations from a base station to an LMF).

In an example implementation, for C-DRX, an LMF of a network can request the DRX configuration of a UE from a base station. Based on this information, the LMF can provide the UE with PRS configuration data to “align” DRX and PRS operations (e.g., such that the UE makes PRS measurements while the UE is in a C-DRX “On” state, and refrains from making PRS measurements while the UE is in a C-DRX “Off” state).

In another example implementation, for C-DRX, a UE can transmit DRX configuration data to the LMF. Based on this information, the LMF can provide the UE with PRS configuration data to align DRX and PRS operations.

In another example implementation, for C-DRX, the UE can be configured to obtain PRS measurements during the C-DRX “On” duration, and to refrain to obtaining PRS measurements using the C-DRX “Off” duration.

In another example implementation, for C-DRX, the base station can signal to the UE that the UE can refrain from making PRS measurements during specific periods of time. For example, the base station can instruct the UE that it can refrain from making PRS measurements during the C-DRX “Off” duration. As another example, the base station can instruct the UE to continue making PRS measurements according to default configured behavior (e.g., making PRS measurements regardless of whether the UE is in a C-DRX “On” duration or C-DRX “Off” duration).

In another example implementation, for Paging DRX, a base station can provide an LMF with information regarding the DRX paging occasions for a particular cell of the network. Based on this information, the LMF can provide one or more UEs in the cell with PRS configuration data to align DRX and PRS operations.

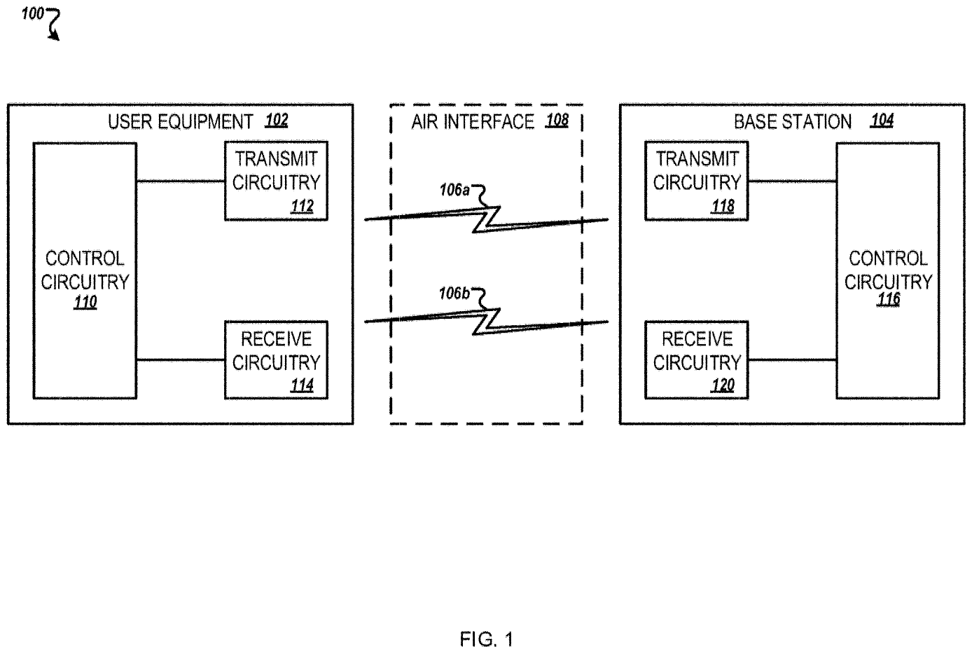

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be an E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE.

The transmit circuitry 112 can perform various operations described in this specification. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

As described above, a user equipment (UE) can operate according to a DRX process, whereby the UE does not continuously monitor for paging messages from the network. Example paging message include those transmitted by a base station of the network to the UE (e.g., using one or more physical downlink control channels, PDCCHs) to indicate the availability of downlink data from the network that is intended for the UE.

Further, a network can determine the location of certain devices of a network (e.g., one or more UEs) using a PRS. For example, a UE can obtain measurements of one or more PRSes transmitted by a base station, and provide the PRS measurements to a network entity (e.g., a LMF). The network entity can determine the location of the UE based on these measurements, for instance by using positioning techniques such as roundtrip time (RTT), angle of arrival/departure (AoA/AoD), and/or time difference of arrival (TDOA).

To improve the efficiency of the network and its devices, DRX and PRS operations can be “aligned” with one another, such that the UE obtains PRS measurements during the same periods of time in which the UE is also monitoring for paging messages, and refrains from obtaining measurements when the UE is not monitoring for paging messages. This can be beneficial, for example, in enabling the UE to obtain PRS measurements during time periods in which it is otherwise awake, instead of waking the UE specifically for this purpose. Accordingly, the UE can operate in a more power efficient manner.

In some implementations, for C-DRX, an LMF of a network can request the DRX configuration of a UE from a base station. Based on this information, the LMF can provide the UE with PRS configuration data to align DRX and PRS operations (e.g., such that the UE makes PRS measurements while the UE is in a C-DRX “On” state, and refrains from making PRS measurements while the UE is in a C-DRX “Off” state).

In some implementations, DRX and PRS operations can be aligned through the use of signaling between the UE, base station, and/or other network entities (e.g., an LMF). As an example, DRX and PRS operations can be aligned based at least in part on NRPPa signaling (e.g., to transmit configuration data regarding DRX operations from a base station to an LMF).

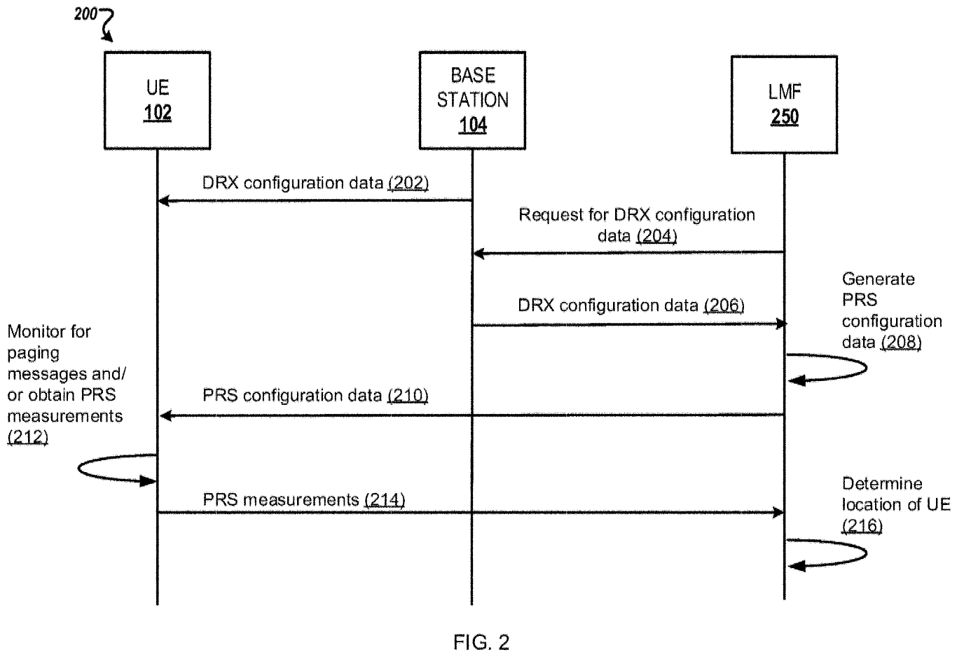

As an example, FIG. 2 shows a process 200 for aligning C-DRX and PRS operations. The process 200 can be performed at least in part by a UE 102, a base station 104, and a LMF 250 of a network.

In the process 200, the base station 104 transmits DRX configuration data to the UE 102 (202). The DRX configuration data specifies one or more parameters for performing DRX (e.g., C-DRX) by the UE 102. As an example, the DRX configuration data can specify parameters such as a DRX ON duration timer, a DRX inactivity timer, a DRX slot offset, a short DRX cycle (including a short DRX cycle timer), and/or a long DRX cycle (including a long DRX cycle timer).

Further, the LMF 250 transmits a request for the DRX configuration data to the base station 104 (204). In some implementations, the request can be transmitted using an NRPPa signaling procedure. For example, the request can be included in one or more NRPPa POSITION INFORMATION REQUEST messages transmitted from the LMF 250 to the base station 104.

In response, the base station 104 transmits at least a portion of the DRX configuration data to the LMF (206). In some implementations, the DRX configuration data also can be transmitted using an NRPPa signaling procedure. For example, the DRX configuration data can be included in one or more NRPPa POSITION INFORMATION RESPONSE and/or POSITION INFORMATION UPDATE messages transmitted from the base station 104 to the LMF 250.

In some implementations, the request can signal the base station 104 to provide DRX configuration information to the LMF 250 according to a particular pattern or scheme.

As an example, the request can signal the base station 104 to provide a single instance of DRX configuration data to the LMF 250 (e.g., an “on demand” request). In response to this request, the base station 104 can transmit a single instance of DRX configuration data regarding the UE 102 to the LMF 250 (e.g., using a POSITION INFORMATION RESPONSE message). Further, the base station 104 can refrain from sending any additional DRX configuration data regarding the UE 102 to the LMF 250 until the LMF 250 transmits another request to the base station 104.

As another example, the request can signal the base station 104 to provide DRX configuration data to the LMF 250 periodically, until the LFM 250 subsequently signals the base station 104 to discontinue doing so. In response to this request, the base station 104 can transmit DRX configuration data regarding the UE 102 to the LMF 250 periodically (e.g., using one or more POSITION INFORMATION UPDATE messages). Further, upon receiving signaling from the LMF 250 to discontinue providing DRX configuration data to the LMF 250 (e.g., using a POSITION INFORMATION RESPONSE message), the base station 104 can refrain from sending any additional DRX configuration data regarding the UE 102 to the LMF 250. In some implementations, the LMF 250 can signal the periodicity for which the base station 104 is to provide DRX configuration data to the LMF 250.

The LMF 250 generates PRS configuration data based on the DRX configuration data (208). In general, the PRS configuration data specifies one or more parameters form obtaining PRS measurements by the UE 102. As an example, the PRS configuration data can specify parameters such as a subframe offset of PRS (e.g., to align the PRS with DRX operations, such as with the C-DRX “On” states).

Further, the LMF 250 transmits the PRS configuration data to the UE 102 (210). In some implementations, the LMF 250 can transmit the PRS configuration data to the UE 102 via LPP signaling.

The UE 102 monitors for paging messages and/or obtains PRS measurements according to the DRX configuration data and the PRS configuration data, respectively (212). In particular, the UE 102 can monitor for paging messages and/or obtain PRS measurements in a RRC_CONNECTED state (e.g., C-DRX).

In some implementations, the UE 102 can perform these DRX and PRS operations in such a way that they are aligned with one another. For example, based on the DRX configuration data, the UE 102 can determine one or more C-DRX “On” states during which to monitor the network for paging messages. Further, based on the PRS configuration data, the UE 102 can obtain PRS measurements during at least some of the C-DRX “On” states. Further, in some implementations, the UE 102 can refrain from obtaining any PRS measurements during any C-DRX “Off” states.

The UE 102 transmits at least a portion of the PRS measurements to the LMF 250 (214). In some implementations, UE 102 can transmit the PRS measurements to the LMF 250 via LPP signaling.

The LMF 250 determines the location of the UE 102 based on the PRS measurements (216). As an example, the LMF 250 can determine the location of the UE 102 by performing one or more positioning techniques with respect to the PRS measurements, such as roundtrip time (RTT), angle of arrival/departure (AoA/AoD), and/or time difference of arrival (TDOA).

As described above, a request can be transmitted from the LMF 250 to the base station 104 using an NRPPa POSITION INFORMATION REQUEST message. For example, a specification for an NRPPa POSITION INFORMATION REQUEST message can be enhanced to include additional information elements to facilitate the request (e.g., as indicated using underline below).

| IE/Group | | | IE type and | Semantics | | Assigned |
|---|---|---|---|---|---|---|
| Name | Presence | Range | reference | description | Criticality | Criticality |
| Message | M | | 9.2.3 | | YES | reject |
| Type | | | | | | |
| NRPPa | M | | 9.2.4 | | — | |
| Transaction | | | | | | |
| ID | | | | | | |
| Requested | O | | 9.2.27 | | YES | ignore |
| SRS | | | | | | |
| Transmission | | | | | | |
| Characteristics | | | | | | |
| UE | O | | 9.2.70 | | YES | ignore |
| Reporting | | | | | | |
| Information | | | | | | |
| UE TEG | O | | ENUMERATED | | YES | ignore |
| Information | | | (onDemand, | | | |
| Request | | | periodic, stop, . . . ) | | | |
| UE TEG | C- | | ENUMERATED | | YES | reject |
| Reporting | ifUeTegInfo | | (160 ms, 320 ms, | | | |
| Periodicity | ReqPeriodic | | 1280 ms, 2560 ms, | | | |
| | | | 61440 ms, | | | |
| | | | 81920 ms, | | | |
| | | | 368640 ms, | | | |
| | | | 737280 ms, . . . ) | | | |
| UE DRX | O | | ENUMERATED | | YES | ignore |
| Information | | | (onDemand, | | | |
| Request | | | periodic, | | | |
| | | | stop, . . . ) | | | |
| UE DRX | C- | | ENUMERATED | | YES | reject |
| Reporting | ifUeDrxInfo | | (160 ms, 320 ms, | | | |
| Periodicity | ReqPeriodic | | 1280 ms, 2560 ms, | | | |
| | | | 61440 ms, | | | |
| | | | 81920 ms, | | | |
| | | | 368640 ms, | | | |
| | | | 737280 ms, . . . ) | | | |

As described above, DRX configuration data can be transmitted from the base station 104 to the LMF 250 using an NRPPa POSITION INFORMATION RESPONSE message. For example, a specification for an NRPPa POSITION INFORMATION RESPONSE message can be enhanced to include additional information elements to facilitate the transmission of DRX configuration data (e.g., as indicated using underline below).

| IE/Group | | | IE type and | Semantics | | Assigned |
|---|---|---|---|---|---|---|
| Name | Presence | Range | reference | description | Criticality | Criticality |
| Message Type | M | | 9.2.3 | | YES | reject |
| NRPPa | M | | 9.2.4 | | — | |
| Transaction ID | | | | | | |
| SRS | O | | 9.2.28 | | YES | ignore |
| Configuration | | | | | | |
| SFN | O | | Relative | | YES | ignore |
| Initialisation | | | Time 1900 | | | |
| Time | | | 9.2.36 | | | |
| Criticality | O | | 9.2.2 | | YES | ignore |
| Diagnostics | | | | | | |
| UE Tx TEG | O | | 9.2.78 | | YES | ignore |
| Association | | | | | | |
| List | | | | | | |
| UE DRX | O | | | | YES | ignore |
| Configuration | | | | | | |

As described above, DRX configuration data can be transmitted periodically from the base station 104 to the LMF 250 using an NRPPa POSITION INFORMATION UPDATE message. For example, a specification for an NRPPa POSITION INFORMATION UPDATE message can be enhanced to include additional information elements to facilitate the transmission of DRX configuration data (e.g., as indicated using underline below).

| | | | IE type and | Semantics | | Assigned |
|---|---|---|---|---|---|---|
| IE/Group Name | Presence | Range | reference | description | Criticality | Criticality |
| Message Type | M | | 9.2.3 | | YES | ignore |
| NRPPa Transaction | M | | 9.2.4 | | — | |
| ID | | | | | | |
| SRS Configuration | O | | 9.2.28 | | YES | ignore |
| SFN Initialisation | O | | Relative | | YES | ignore |
| Time | | | Time | | | |
| | | | 1900 | | | |
| | | | 9.2.36 | | | |
| UE Tx TEG | O | | 9.2.78 | | YES | ignore |
| Association List | | | | | | |
| UE DRX | O | | | | YES | ignore |
| Configuration | | | | | | |

In some implementations, the DRX configuration data can be signaling using one or more information elements. Example information elements are shown below.

| IE/Group | | | | Semantics | | Assigned |
|---|---|---|---|---|---|---|
| Name | Presence | Range | IE type and reference | description | Criticality | Criticality |
| CHOICE On | M | | | | | |
| Duration | | | | | | |
| Timer | | | | | | |
| >Sub | | | INTEGER (1 . . . 31) | | | |
| milliseconds | | | | | | |
| >milliseconds | | | ENUMERATED (ms1, | | | |
| | | | ms2, ms3, ms4, ms5, | | | |
| | | | ms6, ms8, ms10, ms20, | | | |
| | | | ms30, ms40, ms50, | | | |
| | | | ms60, | | | |
| | | | ms80, ms100, ms200, | | | |
| | | | ms300, ms400, ms500, | | | |
| | | | ms600, ms800, ms1000, | | | |
| | | | ms1200, ms 1600) | | | |
| Inactivity | M | | ENUMERATED (ms0, | | | |
| Timer | | | ms1, ms2, ms3, ms4, | | | |
| | | | ms5, ms6, ms8, ms10, | | | |
| | | | ms20, ms30, ms40, | | | |
| | | | ms50, ms60, ms80, | | | |
| | | | ms100, ms200, ms300, | | | |
| | | | ms500, ms750, ms1280, | | | |
| | | | ms1920, ms2560) | | | |
| Long Cycle | M | | INTEGER (0 . . . 10239) | | | |
| Stat Offset | | | | | | |
| Short DRX | O | | | | | |
| >Short Cycle | | | ENUMERATED (ms2, | | | |
| | | | ms3, ms4, ms5, ms6, | | | |
| | | | ms7, ms8, ms10, ms14, | | | |
| | | | ms16, ms20, ms30, | | | |
| | | | ms32, | | | |
| | | | ms35, ms40, ms64, | | | |
| | | | ms80, ms128, ms160, | | | |
| | | | ms256, ms320, ms512, | | | |
| | | | ms640) | | | |
| >Short Cycle | | | INTEGER (1 . . . 16) | | | |
| Timer | | | | | | |
| Slot Offset | | | INTEGER (1 . . . 16) | | | |

In some implementations, for C-DRX, a UE can transmit DRX configuration information to the LMF (e.g., via LPP signaling). Based on this information, the LMF can provide the UE with PRS configuration data to align DRX and PRS operations.

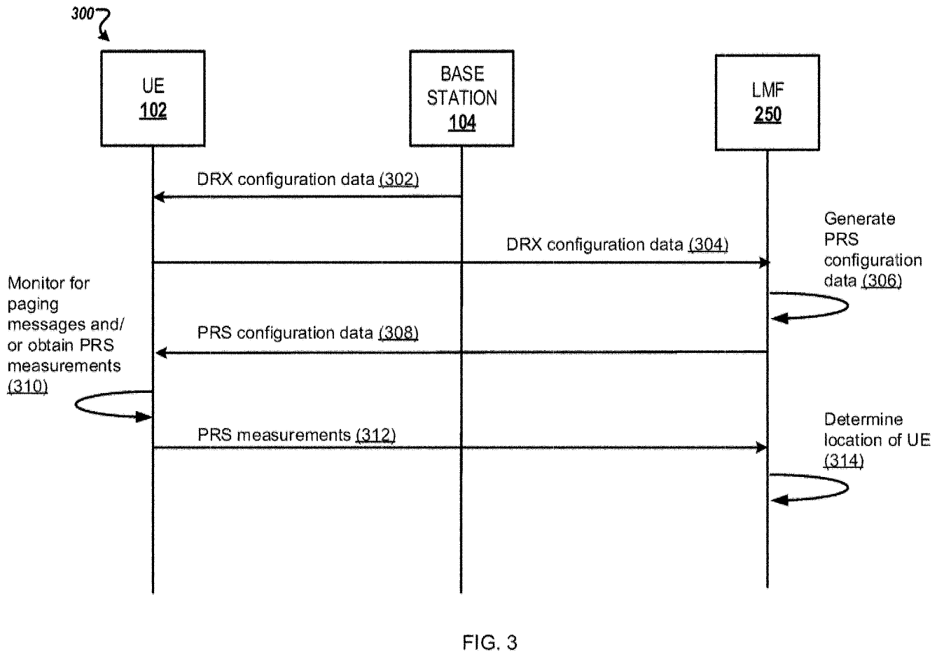

As an example, FIG. 3 shows a process 300 for aligning C-DRX and PRS operations. The process 300 can be performed at least in part by a UE 102, a base station 104, and a LMF 250 of a network.

In the process 300, the base station 104 transmits DRX configuration data to the UE 102 (302). In general, the DRX configuration data specifies one or more parameters for performing DRX (e.g., C-DRX) by the UE 102. Example DRX configuration data is described with reference to FIG. 2.

Further, the UE 102 transmits at least a portion of the DRX configuration data 304 to the LMF 250 (304). In some implementations, the DRX configuration data can be transmitted using an LPP signaling procedure. For example, the DRX configuration data can be included in one or more LPP messages transmitted from the UE 102 to the LMF 250.

The LMF 250 generates PRS configuration data based on the DRX configuration data (306). In general, the PRS configuration data specifies one or more parameters form obtaining PRS measurements by the UE 102. Example PRS configuration data is described with reference to FIG. 2.

Further, the LMF 250 transmits the PRS configuration data to the UE 102 (308). In some implementations, the LMF 250 can transmit the PRS configuration data to the UE 102 via LPP signaling.

The UE 102 monitors for paging messages and/or obtains PRS measurements according to the DRX configuration data and the PRS configuration data, respectively (310). In particular, the UE 102 can monitor for paging messages and/or obtain PRS measurements in a RRC_CONNECTED state (e.g., C-DRX).

In some implementations, the UE 102 can perform these DRX and PRS operations in such a way that they are aligned with one another. For example, based on the DRX configuration data, the UE 102 can determine one or more C-DRX “On” states during which to monitor the network for paging messages. Further, based on the PRS configuration data, the UE 102 can obtain PRS measurements during at least some of the C-DRX “On” states. Further, in some implementations, the UE 102 can refrain from obtaining any PRS measurements during any C-DRX “Off” states.

The UE 102 transmits at least a portion of the PRS measurements to the LMF 250 (312). In some implementations, UE 102 can transmit the PRS measurements to the LMF 250 via LPP signaling.

The LMF 250 determines the location of the UE 102 based on the PRS measurements (314). Example techniques for determining the location of the UE 102 based on PRS measurements are described with reference to FIG. 2.

As described above, DRX configuration data can be transmitted from the UE 102 to the LMF 250 using an LPP message. For example, a LLP message type (e.g., “ProvideAssistanceInformation”) can be defined to include information elements to facilitate the transmission of DRX configuration data (e.g., as indicated using underline and strikethrough below).

- - ASN1START
LPP-MessageBody : := CHOICE {
cl CHOICE {

| | |
|---|---|
| requestCapabilities | RequestCapabilities |
| provideCapabilities | RequestCapabilities |
| requestAssistanceData | RequestAssistanceData |
| provideAssistanceData | ProvideAssistanceData |
| requestLocationinformation | RequestLocationinformation |
| provideLocationinformation | ProvideLocationinformation |
| abort | Abort, |
| error | Error, |

```
    ProvideAssistanceinformation ProvidedAssistanceinformation, [symbol]
    spare6 NULL, spares NULL, spare4 NULL,_spare3 NULL,
    spare2 NULL, sparel NULL, spare0 NULL
```

} ′

messageClassExtension SEQUENCE { }

}
- - ASN1STOP
- - ASN1START

```
ProvideAssistanceinformation : := SEQUENCE
  criticalExtensions  CHOICE {
    cl  CHOICE {
      provideAssistanceinformation-r18
      ProvideAssistanceinformation-r18-IEs, spare3  NULL,  spare2
    NULL, spare1 NULL
    } ,
    criticalExtensionsFuture  SEQUENCE { }
  }
}
ProvideAssistanceinformation-  r18 - IEs : : = SEQUENCE {
  Drx-Config  DRX-Config  OPTIONAL,
  . . . ,
}
- - ASN1STOP
```

In some implementations, an information element presenting the DRX configuration information (e.g., “Drx-Config”) can be defined in a similar manner as in 3GPP Technical Specification (TS) 38.331 (e.g., Release 16 and/or Release 17).

In some implementations, a UE can also signal to the LMF a preference to either (i) align PRS to DRX (e.g., selectively obtain PRS measurements during fixed C-DRX “On” durations), or (ii) align DRX to PRS (e.g., selectively monitor for paging messages during fixed durations during which PRS measurements are obtained).

In some implementations, for C-DRX, a UE can be configured to obtain PRS measurements during the C-DRX “On” duration, and to refrain to obtaining PRS measurements using the C-DRX “Off” duration.

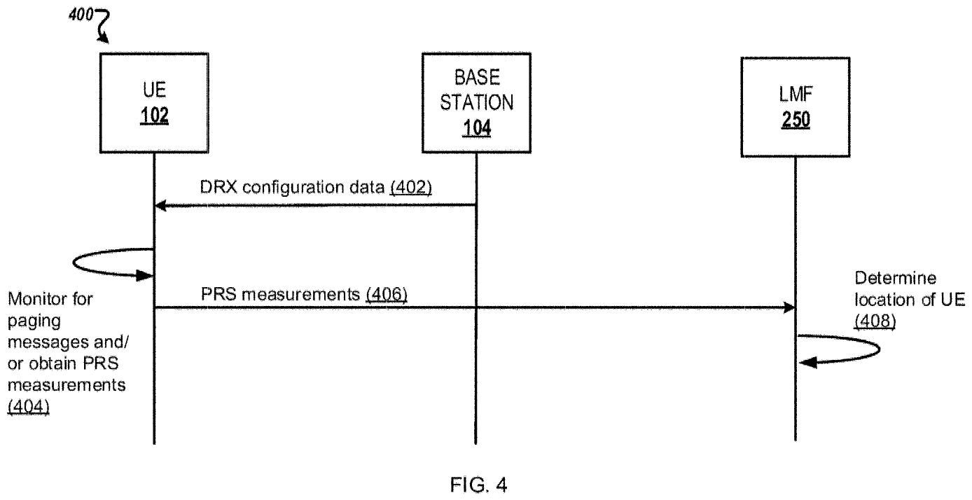

As an example, FIG. 4 shows a process 400 for aligning C-DRX and PRS operations. The process 400 can be performed at least in part by a UE 102, a base station 104, and a LMF 250 of a network.

In the process 400, the base station 104 transmits DRX configuration data to the UE 102 (402). In general, the DRX configuration data specifies one or more parameters for performing DRX (e.g., C-DRX) by the UE 102. Example DRX configuration data is described with reference to FIG. 2.

The UE 102 monitors for paging messages and/or obtains PRS measurements according to the DRX configuration data (404). In particular, the UE 102 can monitor for paging messages and/or obtain PRS measurements in a RRC_CONNECTED state (e.g., C-DRX).

In some implementations, the UE 102 can perform these DRX and PRS operations in such a way that they are aligned with one another. For example, based on the DRX configuration data, the UE 102 can determine one or more C-DRX “On” states during which to monitor the network for paging messages. Further, the UE can be configured to refrain from obtaining PRS measurements during C-DRX “Off” states. Further still, the UE can be configured to obtain PRS measurements during C-DRX “On” states. In some implementations, the UE can be configured to measure only a subset of the PRSes that are transmitted to the UE 102 (e.g., by the base station 104) during the C-DRX “On” states.

The UE 102 transmits at least a portion of the PRS measurements to the LMF 250 (406). In some implementations, UE 102 can transmit the PRS measurements to the LMF 250 via LPP signaling.

The LMF 250 determines the location of the UE 102 based on the PRS measurements (408). Example techniques for determining the location of the UE 102 based on PRS measurements are described with reference to FIG. 2.

In some implementations, the UE 102 can be pre-configured in the manner described above (e.g., pre-configured prior to the performance of DRX and/or PRS operations). In some implementations, the UE 102 can be configured based on signaling by a network (e.g., based on configuration data signaled by a base station of the network to the UE 102).

In some implementations, the process 400 can be performed in conjunction with one or more of the other processes described herein.

In some implementations, for C-DRX, a base station can signal to a UE that the UE can refrain from making PRS measurements during specific periods of time. For example, the base station can instruct the UE that it can refrain from making PRS measurements during the C-DRX “Off” duration. As another example, the base station can instruct the UE to continue making PRS measurements according to default configured behavior (e.g., making PRS measurements regardless of whether the UE is in a C-DRX “On” duration or C-DRX “Off” duration).

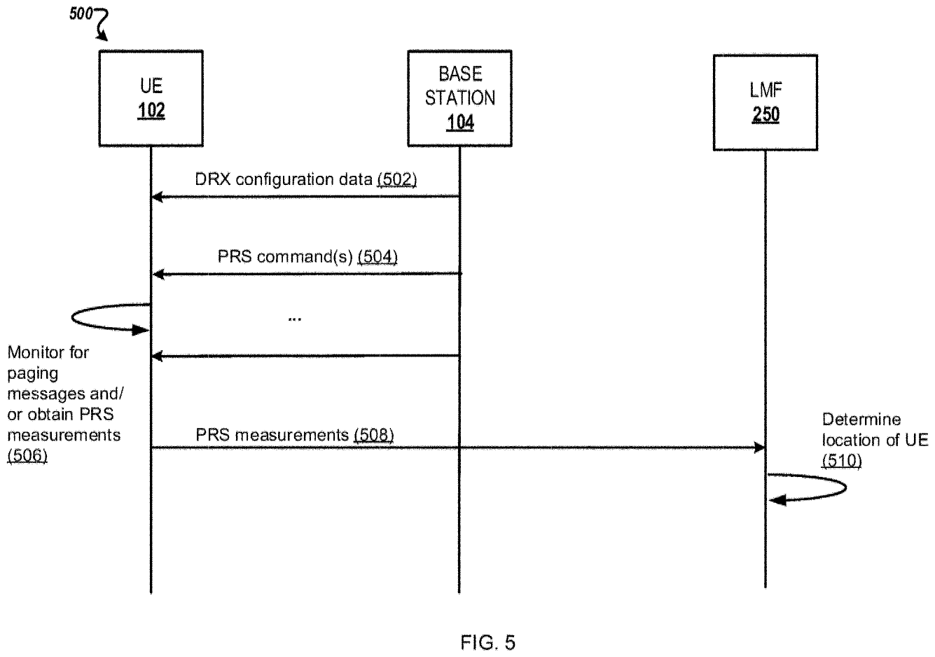

As an example, FIG. 5 shows a process 500 for aligning C-DRX and PRS operations. The process 500 can be performed at least in part by a UE 102, a base station 104, and a LMF 250 of a network.

In the process 500, the base station 104 transmits DRX configuration data to the UE 102 (502). In general, the DRX configuration data specifies one or more parameters for performing DRX (e.g., C-DRX) by the UE 102. Example DRX configuration data is described with reference to FIG. 2.

Further, the base station transmits one or more PRS commands to the UE 102 (504). The one or more PRS commands can control the manner in which the UE 102 obtains PRS measurements and/or refrains from making PRS measurements. In some implementations, at least some of the PRS commands can be transmitted from the base station 104 to the UE 102 via Medium Access Control (MAC) signaling and/or Downlink Control Information (DCI) signaling.

The UE 102 monitors for paging messages and/or obtains PRS measurements according to the DRX configuration data and the one or more PRS commands (506). In particular, the UE 102 can monitor for paging messages and/or obtain PRS measurements in a RRC_CONNECTED state (e.g., C-DRX).

As an example, a PRS command can instruct the UE 102 to begin obtaining PRS measurements. In response to receiving this command, the UE 102 can begin obtaining PRS measurements.

As another example, a PRS command can instruct the UE 102 to discontinue obtaining PRS measurements. In response to receiving this command, the UE 102 can discontinue obtaining PRS measurements.

As another example, a PRS command can instruct the UE 102 to obtain PRS measurements only during C-DRX “On” states. In response to receiving this command, the UE 102 can obtain PRS measurements only during C-DRX “On” states, and refrain from obtaining PRS measurements during C-DRX “Off” states.

As another example, a PRS command can instruct the UE 102 to obtain PRS measurements during both C-DRX “On” states and C-DRX “Off” states. In response to receiving this command, the UE 102 can obtain PRS measurements during both C-DRX “On” states and C-DRX “Off” states.

As another example, a PRS command can signal that the UE 102 is permitted (but is not required) to obtain PRS measurements during both C-DRX “On” states and C-DRX “Off” states. In response to receiving this command, the UE 102 can obtain PRS measurements during C-DRX “On” states and/or during C-DRX “Off” states.

The UE 102 transmits at least a portion of the PRS measurements to the LMF 250 (508). In some implementations, UE 102 can transmit the PRS measurements to the LMF 250 via LPP signaling.

The LMF 250 determines the location of the UE 102 based on the PRS measurements (510). Example techniques for determining the location of the UE 102 based on PRS measurements are described with reference to FIG. 2.

In some implementations, for Paging DRX, a base station can provide an LMF with information regarding the DRX paging occasions for a particular cell of the network. Based on this information, the LMF can provide one or more UEs in the cell with PRS configuration data to align DRX and PRS operations.

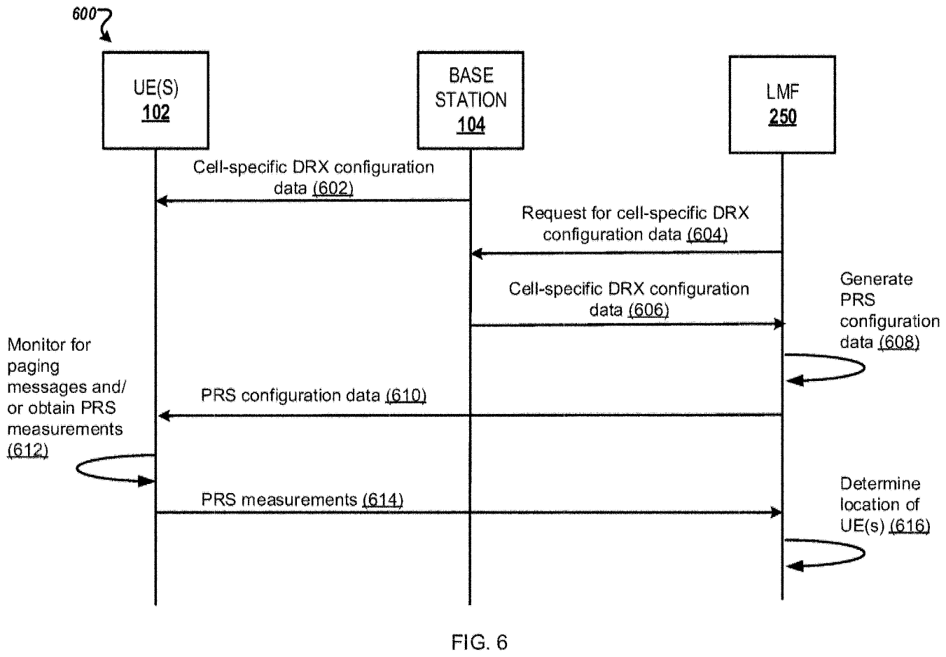

As an example, FIG. 6 shows a process 600 for aligning Paging DRX and PRS operations. The process 200 can be performed at least in part by a UE 102, a base station 104, and a LMF 250 of a network.

In the process 600, the base station 104 transmits DRX configuration data to one or more UE 102s (602). In this example, the DRX configuration information is specific to a particular cell of the network (e.g., a specific wireless cell), and the same cell-specific DRX configuration is transmitted to each of the UEs 102 in that cell.

The DRX configuration data specifies one or more parameters for performing DRX (e.g., Paging DRX) by the UE 102. As an example, the DRX configuration data can specify a number of paging occasions per paging frame (ns). As another example, the DRX configuration data can specify nAndPagingFrameOffset, which can be used to derive the number of total paging frames and paging frame offset. As another example, the DRX configuration data can specify nrofPDCCH-MonitoringOccasionsPerSSB-InPO, which represents the number of PDCCH monitoring occasions. As another example, the DRX configuration data can specify a default paging cycle.

Further, the LMF 250 transmits a request for the DRX configuration data to the base station 104 (604). In some implementations, the request can be transmitted using an NRPPa signaling procedure (e.g., as described wiht reference to FIG. 2). For example, the request can be included in one or more NRPPa TRP POSITION INFORMATION REQUEST messages transmitted from the LMF 250 to the base station 104.

In response, the base station 104 transmits at least a portion of the DRX configuration data to the LMF (606). In some implementations, the DRX configuration data also can be transmitted using an NRPPa signaling procedure (e.g., as described with reference to FIG. 2). For example, the DRX configuration data can be included in one or more NRPPa TRP POSITION INFORMATION RESPONSE and/or TRP POSITION INFORMATION UPDATE messages transmitted from the base station 104 to the LMF 250.

In some implementations, the request can signal the base station 104 to provide DRX configuration information to the LMF 250 according to a particular pattern or scheme (e.g., as described with reference to FIG. 2).

As an example, the request can signal the base station 104 to provide a single instance of DRX configuration data to the LMF 250 (e.g., an “on demand” request). In response to this request, the base station 104 can transmit a single instance of DRX configuration data regarding the cell to the LMF 250 (e.g., using a TRP POSITION INFORMATION RESPONSE message). Further, the base station 104 can refrain from sending any additional DRX configuration data regarding the cell to the LMF 250 until the LMF 250 transmits another request to the base station 104.

As another example, the request can signal the base station 104 to provide DRX configuration data to the LMF 250 periodically, until the LFM 250 subsequently signals the base station 104 to discontinue doing so. In response to this request, the base station 104 can transmit DRX configuration data regarding the cell to the LMF 250 periodically (e.g., using one or more TRP POSITION INFORMATION UPDATE messages). Further, upon receiving signaling from the LMF 250 to discontinue providing DRX configuration data to the LMF 250 (e.g., using a TRP POSITION INFORMATION RESPONSE message), the base station 104 can refrain from sending any additional DRX configuration data regarding the cell to the LMF 250. In some implementations, the LMF 250 can signal the periodicity for which the base station 104 is to provide DRX configuration data to the LMF 250.

In some implementations, a specification for an NRPPa TRP POSITION INFORMATION REQUEST message can be enhanced to include additional information elements to facilitate the request (e.g., in a similar manner as described with reference to FIG. 2).

Further, a specification for an NRPPa TRP POSITION INFORMATION RESPONSE message and/or a NRPPa TRP POSITION INFORMATION UPDATE message can be enhanced to include additional information elements to facilitate the transmission of DRX configuration data (e.g., in a similar manner as described with reference to FIG. 2).

The LMF 250 generates PRS configuration data based on the DRX configuration data (608). In general, the PRS configuration data specifies one or more parameters form obtaining PRS measurements by the UE(s) 102. Example PRS configuration data is described with reference to FIG. 2.

Further, the LMF 250 transmits the PRS configuration data to the UE(s) 102 (610). In some implementations, the LMF 250 can transmit the PRS configuration data to the UE(s) 102 via LPP signaling.

The UE(s) 102 monitor for paging messages and/or obtains PRS measurements according to the DRX configuration data and the PRS configuration data, respectively (612). In particular, the UE 102 can monitor for paging messages and/or obtain PRS measurements in a RRC_IDLE or RRC_INACTIVE state (e.g., Paging DRX).

In some implementations, the UE(s) 102 can perform these DRX and PRS operations in such a way that they are aligned with one another. For example, based on the DRX configuration data, the UE(s) 102 can determine one or more paging occasions during which to monitor the network for paging messages. Further, based on the PRS configuration data, the UE(s) 102 can obtain PRS measurements during at least some of the paging occasions. Further, in some implementations, the UE(s) 102 can refrain from obtaining any PRS measurements outside of the paging occasions.

The UE(s) 102 transmit at least a portion of the PRS measurements to the LMF 250 (614). In some implementations, UE(s) 102 can transmit the PRS measurements to the LMF 250 via LPP signaling.

The LMF 250 determines the location of the UE(s) 102 based on the PRS measurements (616). Example techniques for determining the location of the UE(s) 102 based on PRS measurements are described with reference to FIG. 2.

### Example Methods

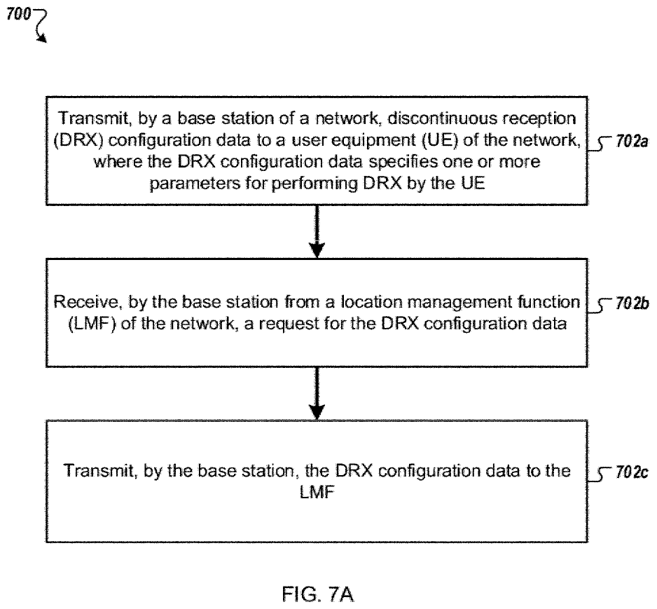

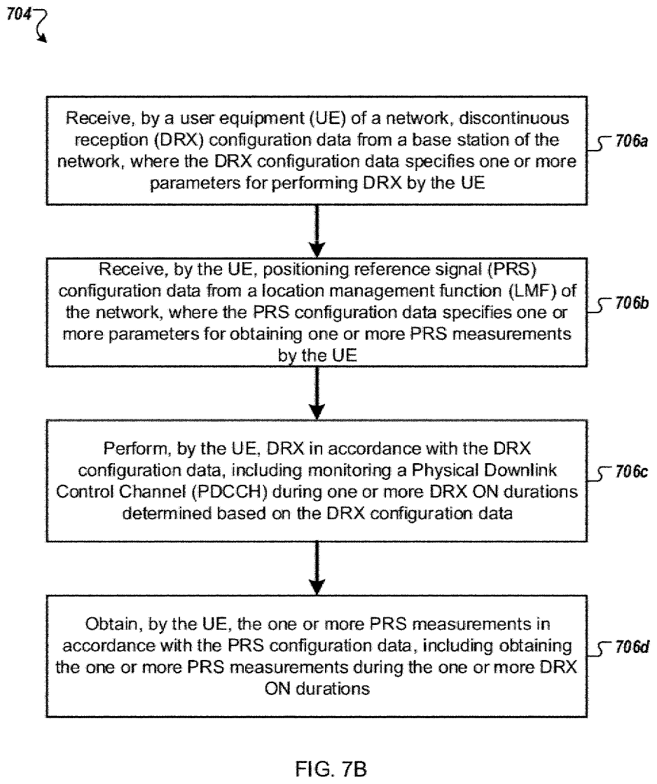

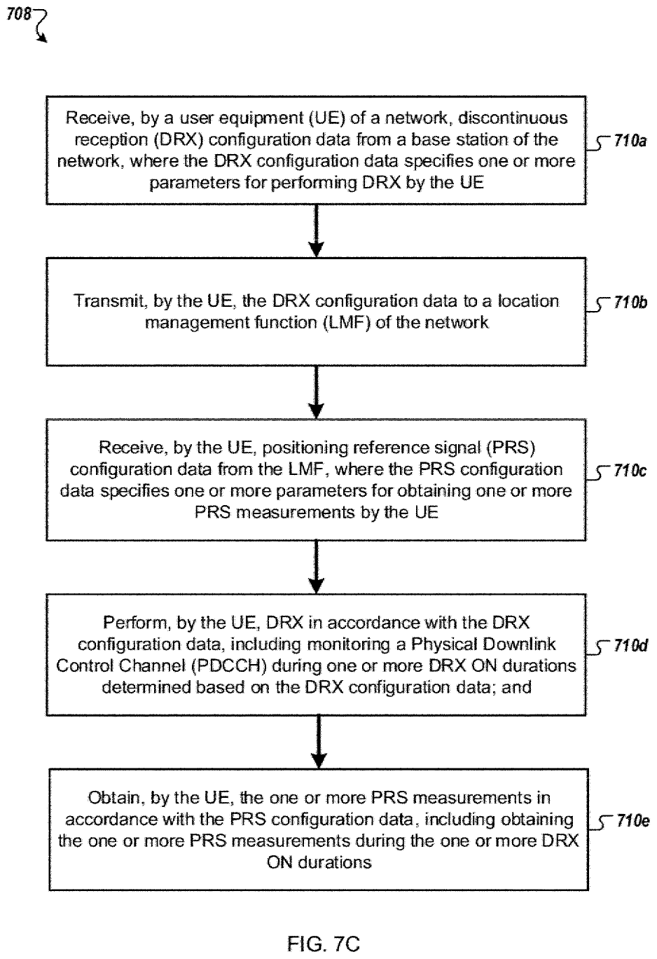

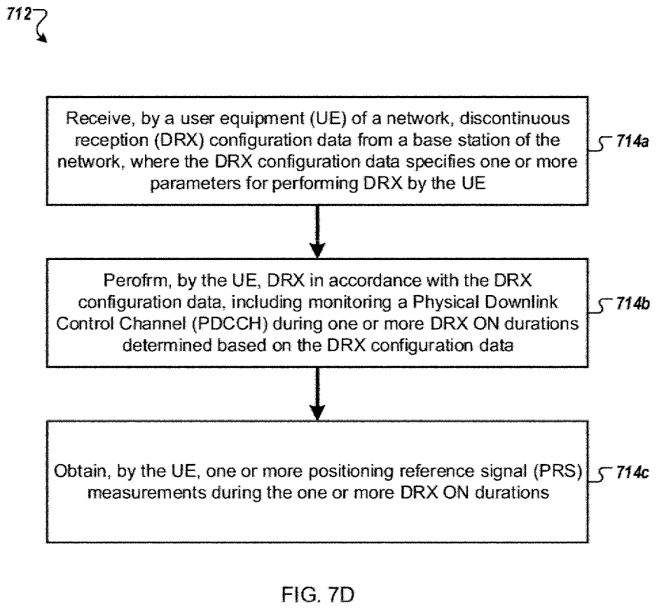

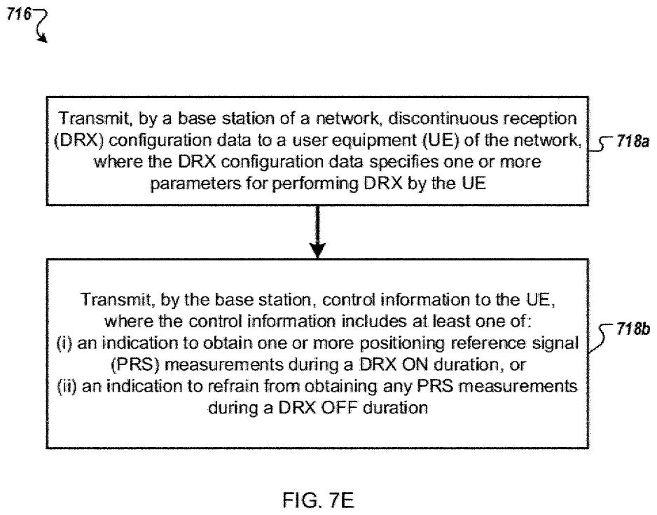

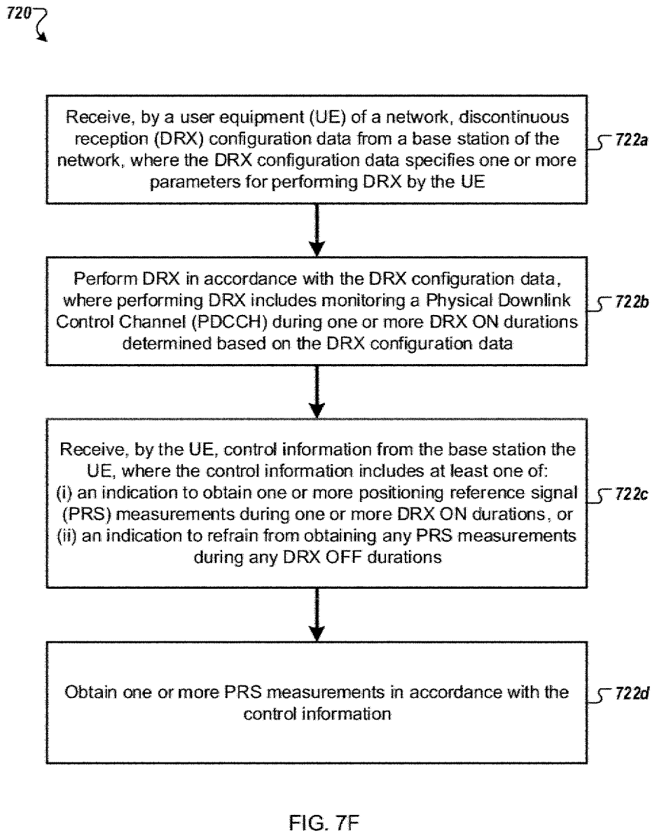

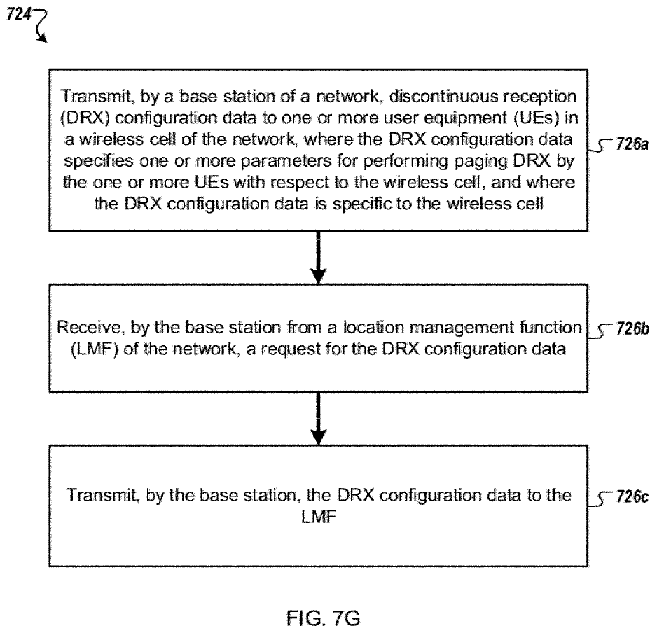

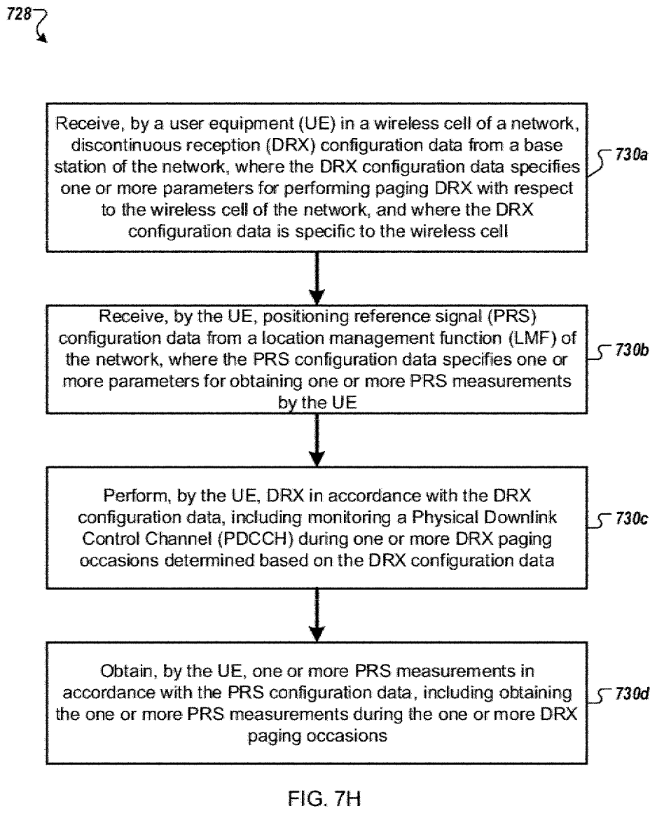

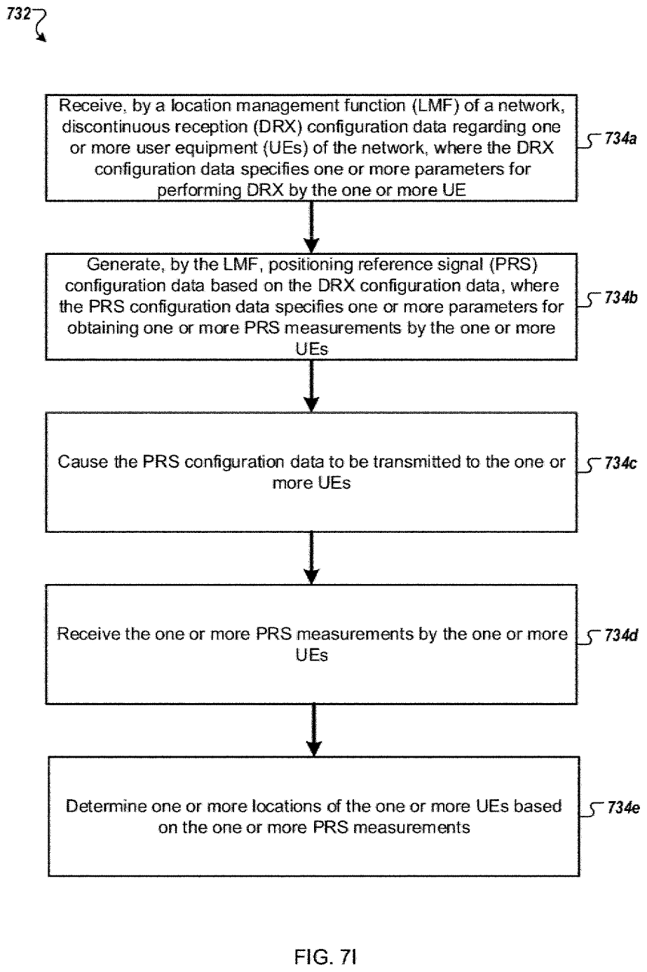

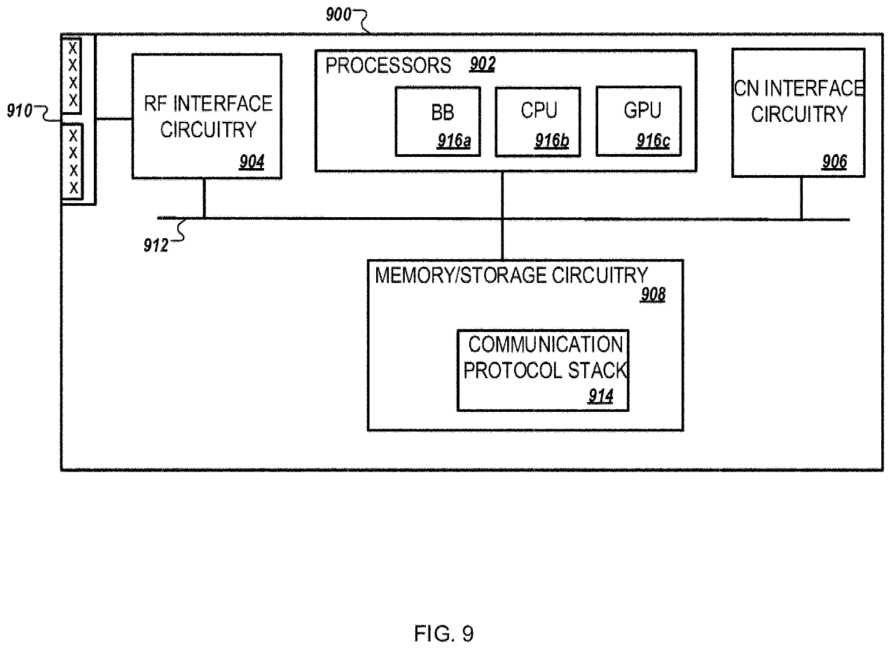

FIG. 7A illustrates a flowchart of an example method 700. For clarity of presentation, the description that follows generally describes method 700 in the context of the other figures in this description. For example, method 700 can be performed, at least in part, by the base station 104 and/or the access node 900 shown in FIGS. 1 and 9, respectively. It will be understood that method 700 can be performed, for example, by any suitable system, environment, software, hardware, or a combination of systems, environments, software, and hardware, as appropriate. In some implementations, various steps of method 700 can be run in parallel, in combination, in loops, or in any order.

According to the method 700, a base station of a network transmits discontinuous reception (DRX) configuration data to a user equipment (UE) of the network (702a). The DRX configuration data specifies one or more parameters for performing DRX by the UE.

In some implementations, the DRX configuration data can specify one or more parameters for performing DRX by the UE in a RRC_CONNECTED state.

In some implementations, the DRX configuration data can specify one or more parameters for performing Connected Mode DRX (C-DRX) by the UE.

In some implementations, the DRX configuration data include one or more of: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

Further the base station receives, from a location management function (LMF) of the network, a request for the DRX configuration data (702b).

In some implementations, the request can be included in a POSITIONING INFORMATION REQUEST message transmitted to the base station by the LMF.

In some implementations, the DRX configuration data can be included in at least one of a POSITIONING INFORMATION RESPONSE message or a POSITIONING INFORMATION UPDATE MESSAGE transmitted by the base station to the LMF.

Further, the base station transmits the DRX configuration data to the LMF (702c).

In some implementations, the request can signal the base station to transmit a single instance of the DRX configuration data to the LMF. Further, transmitting the DRX configuration data to the LMF can include transmitting the single instance of the DRX configuration data to the LMF.

In some implementations, the request can signal the base station to transmit the DRX configuration data to the LMF periodically until receipt of a second request signaling the base station to discontinue providing the DRX configuration data to the LMF. Further, transmitting the DRX configuration data to the LMF can include transmitting the DRX configuration data to the LMF periodically until receipt of the second request.

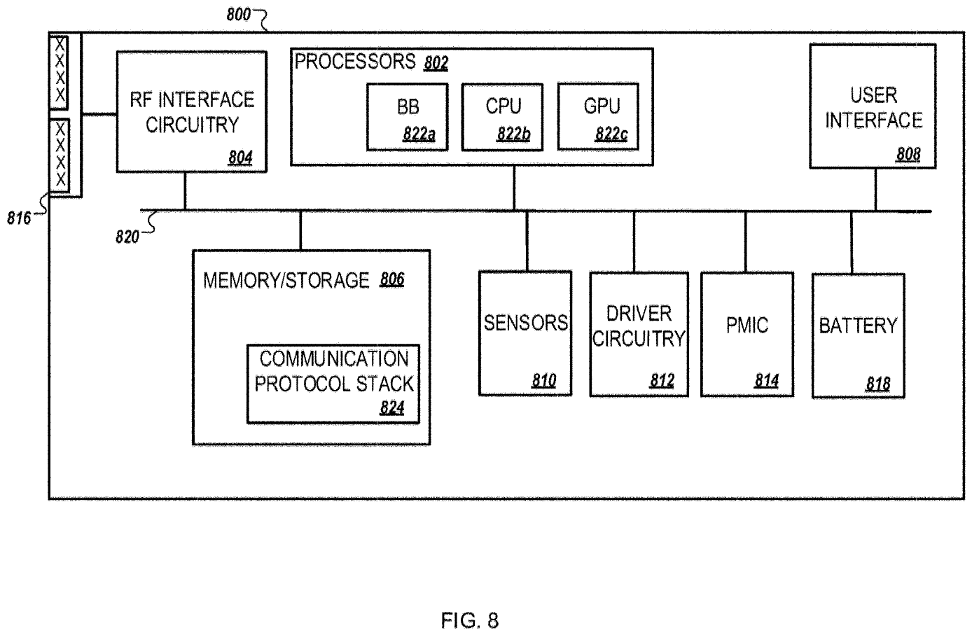

FIG. 7B illustrates a flowchart of an example method 704. For clarity of presentation, the description that follows generally describes method 704 in the context of the other figures in this description. For example, method 704 can be performed, at least in part, by the UE 102 and/or UE 800 shown in FIGS. 1 and 8, respectively. It will be understood that method 704 can be performed, for example, by any suitable system, environment, software, hardware, or a combination of systems, environments, software, and hardware, as appropriate. In some implementations, various steps of method 704 can be run in parallel, in combination, in loops, or in any order.

According to the method 704, a user equipment (UE) of a network receives discontinuous reception (DRX) configuration data from a base station of the network, where the DRX configuration data specifies one or more parameters for performing DRX by the UE (706a).

In some implementations, the DRX configuration data can specify one or more parameters for performing DRX by the UE in a RRC_CONNECTED state.

In some implementations, the DRX configuration data can specify one or more parameters for performing Connected Mode DRX (C-DRX) by the UE.

In some implementations, the DRX configuration data can include one or more of the following: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

Further, the UE receives positioning reference signal (PRS) configuration data from a location management function (LMF) of the network, where the PRS configuration data specifies one or more parameters for obtaining one or more PRS measurements by the UE (706b).

Further, the UE performs DRX in accordance with the DRX configuration data, where performing DRX includes monitoring a Physical Downlink Control Channel (PDCCH) during one or more DRX ON durations determined based on the DRX configuration data (706c).

Further, the UE obtains the one or more PRS measurements in accordance with the PRS configuration data, where obtaining the one or more PRS measurements in accordance with the PRS configuration data includes obtaining the one or more PRS measurements during the one or more DRX ON durations (706d).

In some implementations, the method 704 can also include refraining from obtaining any PRS measurements during any DRX OFF durations.

In some implementations, the method 704 can also include transmitting the one or more PRS measurements to the LMF.

FIG. 7C illustrates a flowchart of an example method 708. For clarity of presentation, the description that follows generally describes method 708 in the context of the other figures in this description. For example, method 708 can be performed, at least in part, by the UE 102 and/or UE 800 shown in FIGS. 1 and 8, respectively. It will be understood that method 708 can be performed, for example, by any suitable system, environment, software, hardware, or a combination of systems, environments, software, and hardware, as appropriate. In some implementations, various steps of method 708 can be run in parallel, in combination, in loops, or in any order.

According to the method 708, a user equipment (UE) of a network receives discontinuous reception (DRX) configuration data from a base station of the network, where the DRX configuration data specifies one or more parameters for performing DRX by the UE (710a).

In some implementations, the DRX configuration data can specify one or more parameters for performing DRX by the UE in a RRC_CONNECTED state.

In some implementations, the DRX configuration data can specify one or more parameters for performing Connected Mode DRX (C-DRX) by the UE.

In some implementations, the DRX configuration can include one or more of the following: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

Further, the UE transmits the DRX configuration data to a location management function (LMF) of the network (710b).

In some implementations the DRX configuration data can be included in an LTE Position Protocol (LPP) message transmitted by the UE to the LMF.

Further, the UE receives positioning reference signal (PRS) configuration data from the LMF, where the PRS configuration data specifies one or more parameters for obtaining one or more PRS measurements by the UE (710c).

Further, the UE performs DRX in accordance with the DRX configuration data, where performing DRX includes monitoring a Physical Downlink Control Channel (PDCCH) during one or more DRX ON durations determined based on the DRX configuration data (710d).

Further, the UE obtains the one or more PRS measurements in accordance with the PRS configuration data, where obtaining the one or more PRS measurements in accordance with the PRS configuration data includes obtaining the one or more PRS measurements during the one or more DRX ON durations (710e).

In some implementations, the method 708 can include refraining from obtaining any PRS measurements during any DRX OFF durations.

In some implementations, the method 708 can include transmitting the one or more PRS measurements to the LMF.

FIG. 7D illustrates a flowchart of an example method 712. For clarity of presentation, the description that follows generally describes method 712 in the context of the other figures in this description. For example, method 712 can be performed, at least in part, by the UE 102 and/or UE 800 shown in FIGS. 1 and 8, respectively. It will be understood that method 712 can be performed, for example, by any suitable system, environment, software, hardware, or a combination of systems, environments, software, and hardware, as appropriate. In some implementations, various steps of method 712 can be run in parallel, in combination, in loops, or in any order.

According to the method 712, a user equipment (UE) of a network receives discontinuous reception (DRX) configuration data from a base station of the network, where the DRX configuration data specifies one or more parameters for performing DRX by the UE (714a).

In some implementations, the DRX configuration data can specify one or more parameters for performing DRX by the UE in a RRC_CONNECTED state.

In some implementations, the DRX configuration data can specify one or more parameters for performing Connected Mode DRX (C-DRX) by the UE.

In some implementations, the DRX configuration can include one or more of the following: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

Further, the UE performs DRX in accordance with the DRX configuration data, where performing DRX includes monitoring a Physical Downlink Control Channel (PDCCH) during one or more DRX ON durations determined based on the DRX configuration data (714b).

Further, the UE obtains one or more positioning reference signal (PRS) measurements during the one or more DRX ON durations (714c).

In some implementations, the method 712 includes refraining from obtaining any PRS measurements during any DRX OFF durations.

In some implementations, the method 712 can include transmitting the one or more PRS measurements to a location management function (LMF) of the network.

FIG. 7E illustrates a flowchart of an example method 716. For clarity of presentation, the description that follows generally describes method 716 in the context of the other figures in this description. For example, method 716 can be performed, at least in part, by the base station 104 and/or the access node 900 shown in FIGS. 1 and 9, respectively. It will be understood that method 716 can be performed, for example, by any suitable system, environment, software, hardware, or a combination of systems, environments, software, and hardware, as appropriate. In some implementations, various steps of method 716 can be run in parallel, in combination, in loops, or in any order.

According to the method 716, a base station of a network transmits discontinuous reception (DRX) configuration data to a user equipment (UE) of the network, where the DRX configuration data specifies one or more parameters for performing DRX by the UE (718a).

In some implementations, the DRX configuration data can specify one or more parameters for performing DRX by the UE in a RRC_CONNECTED state.

In some implementations, the DRX configuration data can specify one or more parameters for performing Connected Mode DRX (C-DRX) by the UE.

In some implementations, the DRX configuration can include one or more of the following: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

Further, the base station transmits control information to the UE, where the control information includes at least one of: an indication to obtain one or more positioning reference signal (PRS) measurements during a DRX ON duration, or an indication to refrain from obtaining any PRS measurements during a DRX OFF duration (718b).

In some implementations, the control information can be transmitted to the UE via Medium Access Control (MAC) signaling.

In some implementations, the control information can be transmitted to the UE via Downlink Control Information (DCI) signaling.

FIG. 7F illustrates a flowchart of an example method 720. For clarity of presentation, the description that follows generally describes method 720 in the context of the other figures in this description. For example, method 720 can be performed, at least in part, by the UE 102 and/or UE 800 shown in FIGS. 1 and 8, respectively. It will be understood that method 720 can be performed, for example, by any suitable system, environment, software, hardware, or a combination of systems, environments, software, and hardware, as appropriate. In some implementations, various steps of method 720 can be run in parallel, in combination, in loops, or in any order.

According to the method 720, a user equipment (UE) of a network receives discontinuous reception (DRX) configuration data from a base station of the network, where the DRX configuration data specifies one or more parameters for performing DRX by the UE (722a).

In some implementations, the DRX configuration data can specify one or more parameters for performing DRX by the UE in a RRC_CONNECTED state.

In some implementations, the DRX configuration data can specify one or more parameters for performing Connected Mode DRX (C-DRX) by the UE.

In some implementations, the DRX configuration can include one or more of the following: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

The UE performs DRX in accordance with the DRX configuration data, where performing DRX includes monitoring a Physical Downlink Control Channel (PDCCH) during one or more DRX ON durations determined based on the DRX configuration data (722b).

The UE receives control information from the base station the UE, where the control information includes at least one of: an indication to obtain one or more positioning reference signal (PRS) measurements during one or more DRX ON durations, or an indication to refrain from obtaining any PRS measurements during any DRX OFF durations (722c).

In some implementations, the control information can be received from the base station via Medium Access Control (MAC) signaling.

In some implementations, wherein the control information can be received from the base station via Downlink Control Information (DCI) signaling.

The UE obtains one or more PRS measurements in accordance with the control information (722d).

In some implementations, the method 720 can include transmitting the one or more PRS measurements to a location management function (LMF) of the network.

FIG. 7G illustrates a flowchart of an example method 724. For clarity of presentation, the description that follows generally describes method 724 in the context of the other figures in this description. For example, method 724 can be performed, at least in part, by the base station 104 and/or the access node 900 shown in FIGS. 1 and 9, respectively. It will be understood that method 724 can be performed, for example, by any suitable system, environment, software, hardware, or a combination of systems, environments, software, and hardware, as appropriate. In some implementations, various steps of method 724 can be run in parallel, in combination, in loops, or in any order.

According to the method 724, a base station of a network transmits discontinuous reception (DRX) configuration data to one or more user equipment (UEs) in a wireless cell of the network, where the DRX configuration data specifies one or more parameters for performing paging DRX (also known as Idle Mode DRX) by the one or more UEs with respect to the wireless cell, and where the DRX configuration data is specific to the wireless cell (726a).

In some implementations, the DRX configuration data can specify one or more parameters for performing DRX by the one or more UEs in a RRC_INACTIVE or RRC_IDLE state.

In some implementations, the DRX configuration data can include an information element representing a paging occasion configuration (e.g., in connection with paging DRX).

Further, the base station receives, from a location management function (LMF) of the network, a request for the DRX configuration data (block 726b).

In some implementations, the request can be included in a TRP INFORMATION REQUEST message transmitted to the base station by the LMF.

In some implementations, the DRX configuration data can be included in at least one of a TRP POSITIONING INFORMATION RESPONSE message or a TRP POSITIONING INFORMATION UPDATE MESSAGE transmitted by the base station to the LMF.

Further, the base station transmits the DRX configuration data to the LMF (726c).

In some implementations, the request can signal the base station to transmit a single instance of the DRX configuration data to the LMF. Further, transmitting the DRX configuration data to the LMF can include transmitting the single instance of the DRX configuration data to the LMF.

In some implementations, the request can signal the base station to transmit the DRX configuration data to the LMF periodically until receipt of a second request signaling the base station to discontinue providing the DRX configuration data to the LMF. Further, transmitting the DRX configuration data to the LMF can include transmitting the DRX configuration data to the LMF periodically until receipt of the second request.

FIG. 7H illustrates a flowchart of an example method 728. For clarity of presentation, the description that follows generally describes method 728 in the context of the other figures in this description. For example, method 728 can be performed, at least in part, by the UE 102 and/or UE 800 shown in FIGS. 1 and 8, respectively. It will be understood that method 728 can be performed, for example, by any suitable system, environment, software, hardware, or a combination of systems, environments, software, and hardware, as appropriate. In some implementations, various steps of method 728 can be run in parallel, in combination, in loops, or in any order.

According to the method 728, a user equipment (UE) of a wireless cell of a network receives discontinuous reception (DRX) configuration data from a base station of the network, where the DRX configuration data specifies one or more parameters for performing paging DRX (also known as Idle Mode DRX) with respect to the wireless cell of the network, and where the DRX configuration data is specific to the wireless cell (730a).

In some implementations, the DRX configuration data can specify one or more parameters for performing DRX by the UE in a RRC_INACTIVE or RRC_IDLE state.

In some implementations, the DRX configuration data can include an information element representing a paging occasion configuration (e.g., in connection with paging DRX).

Further, the UE receives positioning reference signal (PRS) configuration data from a location management function (LMF) of the network, where the PRS configuration data specifies one or more parameters for obtaining one or more PRS measurements by the UE (730b).

Further, the UE performs DRX in accordance with the DRX configuration data, where performing DRX includes monitoring a Physical Downlink Control Channel (PDCCH) during one or more DRX paging occasions determined based on the DRX configuration data ((730c).

Further, the UE obtains one or more PRS measurements in accordance with the PRS configuration data, where obtaining the one or more PRS measurements in accordance with the PRS configuration data includes obtaining the one or more PRS measurements during the one or more DRX paging occasions (730d).

In some implementations, the method 728 can also include refraining from obtaining any PRS measurements during any paging occasions.

In some implementations, the method 728 can also include transmitting the one or more PRS measurements to the LMF.

FIG. 7I illustrates a flowchart of an example method 732. For clarity of presentation, the description that follows generally describes method 732 in the context of the other figures in this description. For example, method 732 can be performed, at least in part, by the location management function (LMF) 250 shown in FIGS. 3-6. It will be understood that method 732 can be performed, for example, by any suitable system, environment, software, hardware, or a combination of systems, environments, software, and hardware, as appropriate. In some implementations, various steps of method 732 can be run in parallel, in combination, in loops, or in any order.

According to the method 732, a location management function (LMF) of a network receives discontinuous reception (DRX) configuration data regarding one or more user equipment (UEs) of the network, where the DRX configuration data specifies one or more parameters for performing DRX by the one or more UE (734a).

In some implementations, the DRX configuration data can include one or more of the following: an information element representing a DRX ON duration timer with respect to the one or more UE, an information element representing a DRX inactivity timer with respect to the one or more UEs, an information element representing a DRX slot offset with respect to the one or more UEs, an information element representing a short DRX cycle with respect to the one or more UEs, an information element representing a long DRX cycle with respect to the one or more UEs, or an information element representing a paging occasion configuration.

In some implementations, at least a portion of the DRX configuration data can be received from the base station.

In some implementations, at least a portion of the DRX configuration data can be received from the one or more UE.

Further, the LMF generates positioning reference signal (PRS) configuration data based on the DRX configuration data, where the PRS configuration data specifies one or more parameters for obtaining one or more PRS measurements by the one or more UEs (734b).

Further, the LMF causes the PRS configuration data to be transmitted to the one or more UEs (734c).

Further, the LMF receives the one or more PRS measurements by the one or more UEs (734d).

Further, the LMF determines one or more locations of the one or more UEs based on the one or more PRS measurements (734e).

The example methods shown in FIGS. 7A-7I can be modified or reconfigured to include additional, fewer, or different steps (not shown in FIGS. 7A-7I), which can be performed in the order shown or in a different order.

### Example Systems and Devices

FIG. 8 illustrates an example UE 800, according to some implementations. The UE 800 may be similar to and substantially interchangeable with UE 102 of FIG. 1.

The UE 800 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 800 may include processors 802, RF interface circuitry 804, memory/storage 806, user interface 808, sensors 810, driver circuitry 812, power management integrated circuit (PMIC) 814, one or more antenna(s) 816, and battery 818. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 820, which may represent any type of interface, input/output, bus (local, system, or expansion), transmission line, trace, optical connection, etc. that allows various circuit components (on common or different chips or chipsets) to interact with one another.

The processors 802 may include processor circuitry such as, for example, baseband processor circuitry (BB) 822A, central processor unit circuitry (CPU) 822B, and graphics processor unit circuitry (GPU) 822C. The processors 802 may include any type of circuitry or processor circuitry that executes or otherwise operates computer-executable instructions, such as program code, software modules, or functional processes from memory/storage 806 to cause the UE 800 to perform operations as described herein.

In some implementations, the baseband processor circuitry 822A may access a communication protocol stack 824 in the memory/storage 806 to communicate over a 3GPP compatible network. In general, the baseband processor circuitry 822A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 804. The baseband processor circuitry 822A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 806 may include one or more non-transitory, computer-readable media that includes instructions (for example, communication protocol stack 824) that may be executed by one or more of the processors 802 to cause the UE 800 to perform various operations described herein. The memory/storage 806 include any type of volatile or non-volatile memory that may be distributed throughout the UE 800. In some implementations, some of the memory/storage 806 may be located on the processors 802 themselves (for example, L1 and L2 cache), while other memory/storage 806 is external to the processors 802 but accessible thereto via a memory interface. The memory/storage 806 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 804 may include transceiver circuitry and radio frequency front module (RFEM) that allows the UE 800 to communicate with other devices over a radio access network. The RF interface circuitry 804 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 816 and proceed to filter and amplify (with a low-noise amplifier) the signal. The signal may be provided to a receiver of the transceiver that downconverts the RF signal into a baseband signal that is provided to the baseband processor of the processors 802.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 816. In various implementations, the RF interface circuitry 804 may be configured to transmit/receive signals in a manner compatible with NR access technologies.

The antenna(s) 816 may include one or more antenna elements to convert electrical signals into radio waves to travel through the air and to convert received radio waves into electrical signals. The antenna elements may be arranged into one or more antenna panels. The antenna(s) 816 may have antenna panels that are omnidirectional, directional, or a combination thereof to enable beamforming and multiple input, multiple output communications. The antenna(s) 816 may include microstrip antennas, printed antennas fabricated on the surface of one or more printed circuit boards, patch antennas, phased array antennas, etc. The antenna(s) 816 may have one or more panels designed for specific frequency bands including bands in FR1 or FR2.

The user interface 808 includes various input/output (I/O) devices designed to enable user interaction with the UE 800. The user interface 808 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 800.

The sensors 810 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 812 may include software and hardware elements that operate to control particular devices that are embedded in the UE 800, attached to the UE 800, or otherwise communicatively coupled with the UE 800. The driver circuitry 812 may include individual drivers allowing other components to interact with or control various input/output (I/O) devices that may be present within, or connected to, the UE 800. For example, driver circuitry 812 may include a display driver to control and allow access to a display device, a touchscreen driver to control and allow access to a touchscreen interface, sensor drivers to obtain sensor readings of sensors 810 and control and allow access to sensors 810, drivers to obtain actuator positions of electro-mechanic components or control and allow access to the electro-mechanic components, a camera driver to control and allow access to an embedded image capture device, audio drivers to control and allow access to one or more audio devices.

The PMIC 814 may manage power provided to various components of the UE 800. In particular, with respect to the processors 802, the PMIC 814 may control power-source selection, voltage scaling, battery charging, or DC-to-DC conversion.

In some implementations, the PMIC 814 may control, or otherwise be part of, various power saving mechanisms of the UE 800. A battery 818 may power the UE 800, although in some examples the UE 800 may be mounted deployed in a fixed location, and may have a power supply coupled to an electrical grid. The battery 818 may be a lithium ion battery, a metal-air battery, such as a zinc-air battery, an aluminum-air battery, a lithium-air battery, and the like. In some implementations, such as in vehicle-based applications, the battery 818 may be a typical lead-acid automotive battery.

FIG. 9 illustrates an example access node 900 (e.g., a base station or gNB), according to some implementations. The access node 900 may be similar to and substantially interchangeable with base station 104. The access node 900 may include processors 902, RF interface circuitry 904, core network (CN) interface circuitry 906, memory/storage circuitry 908, and one or more antenna(s) 910.

The components of the access node 900 may be coupled with various other components over one or more interconnects 912. The processors 902, RF interface circuitry 904, memory/storage circuitry 908 (including communication protocol stack 914), antenna(s) 910, and interconnects 912 may be similar to like-named elements shown and described with respect to FIG. 8. For example, the processors 902 may include processor circuitry such as, for example, baseband processor circuitry (BB) 916A, central processor unit circuitry (CPU) 916B, and graphics processor unit circuitry (GPU) 916C.

The CN interface circuitry 906 may provide connectivity to a core network, for example, a 5th Generation Core network (5GC) using a 5GC-compatible network interface protocol such as carrier Ethernet protocols, or some other suitable protocol. Network connectivity may be provided to/from the access node 900 via a fiber optic or wireless backhaul. The CN interface circuitry 906 may include one or more dedicated processors or FPGAs to communicate using one or more of the aforementioned protocols. In some implementations, the CN interface circuitry 906 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 900 that operates in an NR or 5G system (for example, a gNB), and the term “E-UTRAN node” or the like may refer to an access node 900 that operates in an LTE or 4G system (e.g., an eNB). According to various implementations, the access node 900 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 900 may be implemented as one or more software entities running on server computers as part of a virtual network, which may be referred to as a CRAN and/or a virtual baseband unit pool (vBBUP). In V2X scenarios, the access node 900 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Further Examples

In the following sections, further exemplary embodiments are provided.

Example A1 includes a method comprising: transmitting, by a base station of a network, discontinuous reception (DRX) configuration data to a user equipment (UE) of the network, wherein the DRX configuration data specifies one or more parameters for performing DRX by the UE; receiving, by the base station from a location management function (LMF) of the network, a request for the DRX configuration data; and transmitting, by the base station, the DRX configuration data to the LMF.

Example A2 includes the method of Example A1. Further, the request is included in a POSITIONING INFORMATION REQUEST message transmitted to the base station by the LMF.

Example A3 includes the method of Example A2. Further, the DRX configuration data is included in at least one of a POSITIONING INFORMATION RESPONSE message or a POSITIONING INFORMATION UPDATE MESSAGE transmitted by the base station to the LMF.

Example A4 includes the method of Example A1. Further, the request signals the base station to transmit a single instance of the DRX configuration data to the LMF, and wherein transmitting the DRX configuration data to the LMF comprises transmitting the single instance of the DRX configuration data to the LMF.

Example A5 includes the method of Example A1. Further, the request signals the base station to transmit the DRX configuration data to the LMF periodically until receipt of a second request signaling the base station to discontinue providing the DRX configuration data to the LMF, and wherein transmitting the DRX configuration data to the LMF comprises transmitting the DRX configuration data to the LMF periodically until receipt of the second request.

Example A6 includes the method of Example A1. Further, the DRX configuration data comprises at least one of: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

Example A7 includes the method of Example A1. Further, the DRX configuration data specifies one or more parameters for performing DRX by the UE in a RRC_CONNECTED state.

Example A8 includes the method of Example A1. Further, the DRX configuration data specifies one or more parameters for performing Connected Mode DRX (C-DRX) by the UE.

Example B1 includes a base station comprising one or processors and one or more storage devices on which are stored instructions that are operable, when executed by the one or more processors, to cause the one or more processors to perform the method of any of Examples A1 to A8.

Example C1 includes a non-transitory computer storage medium encoded with instructions that, when executed by one or more processors, cause the one or more processors to perform the method of any of Examples A1 to A8.

Example D1 includes an apparatus comprising one or more baseband processors configured to perform the method of any of Examples A1 to A8.

Example E1 includes a method comprising: receiving, by a user equipment (UE) of a network, discontinuous reception (DRX) configuration data from a base station of the network, wherein the DRX configuration data specifies one or more parameters for performing DRX by the UE; receiving, by the UE, positioning reference signal (PRS) configuration data from a location management function (LMF) of the network, wherein the PRS configuration data specifies one or more parameters for obtaining one or more PRS measurements by the UE; performing, by the UE, DRX in accordance with the DRX configuration data, wherein performing DRX comprises monitoring a Physical Downlink Control Channel (PDCCH) during one or more DRX ON durations determined based on the DRX configuration data; and obtaining, by the UE, the one or more PRS measurements in accordance with the PRS configuration data, wherein obtaining the one or more PRS measurements in accordance with the PRS configuration data comprises obtaining the one or more PRS measurements during the one or more DRX ON durations.

Example E2 includes the method of Example E1. Further, the method comprises refraining from obtaining any PRS measurements during any DRX OFF durations.

Example E3 includes the method of Example E1. Further, the method comprises transmitting the one or more PRS measurements to the LMF.

Example E4 includes the method of Example E1. Further, the DRX configuration data comprises at least one of: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

Example E5 includes the method of Example E1. Further, the DRX configuration data specifies one or more parameters for performing DRX by the UE in a RRC_CONNECTED state.

Example E6 includes the method of Example E1. Further, the DRX configuration data specifies one or more parameters for performing Connected Mode DRX (C-DRX) by the UE.

Example F1 includes a user equipment (UE) comprising one or processors and one or more storage devices on which are stored instructions that are operable, when executed by the one or more processors, to cause the one or more processors to perform the method of any of Examples E1 to E6.

Example G1 includes a non-transitory computer storage medium encoded with instructions that, when executed by one or more processors, cause the one or more processors to perform the method of any of Examples E1 to E6.

Example H1 includes an apparatus comprising one or more baseband processors configured to perform the method of any of Examples E1 to E6.

Example I1 includes a method comprising: receiving, by a user equipment (UE) of a network, discontinuous reception (DRX) configuration data from a base station of the network, wherein the DRX configuration data specifies one or more parameters for performing DRX by the UE; transmitting, by the UE, the DRX configuration data to a location management function (LMF) of the network; receiving, by the UE, positioning reference signal (PRS) configuration data from the LMF, wherein the PRS configuration data specifies one or more parameters for obtaining one or more PRS measurements by the UE; performing, by the UE, DRX in accordance with the DRX configuration data, wherein performing DRX comprises monitoring a Physical Downlink Control Channel (PDCCH) during one or more DRX ON durations determined based on the DRX configuration data; and obtaining, by the UE, the one or more PRS measurements in accordance with the PRS configuration data, wherein obtaining the one or more PRS measurements in accordance with the PRS configuration data comprises obtaining the one or more PRS measurements during the one or more DRX ON durations.

Example I2 includes the method of Example I1. Further, the DRX configuration data is included in an LTE Position Protocol (LPP) message transmitted by the UE to the LMF.

Example I3 includes the method of Example I1. Further, the method comprises refraining from obtaining any PRS measurements during any DRX OFF durations.

Example I4 includes the method of Example I1. Further, the method comprises transmitting the one or more PRS measurements to the LMF.

Example I5 includes the method of Example I1. Further, the DRX configuration data comprises at least one of: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

Example I6 includes the method of Example I1. Further, the DRX configuration data specifies one or more parameters for performing DRX by the UE in a RRC_CONNECTED state.

Example I7 includes the method of Example I1. Further, the DRX configuration data specifies one or more parameters for performing Connected Mode DRX (C-DRX) by the UE.

Example J1 includes a user equipment (UE) comprising one or processors and one or more storage devices on which are stored instructions that are operable, when executed by the one or more processors, to cause the one or more processors to perform the method of any of Examples I1 to I7.

Example K1 includes a non-transitory computer storage medium encoded with instructions that, when executed by one or more processors, cause the one or more processors to perform the method of any of Examples I1 to I7.

Example L1 includes an apparatus comprising one or more baseband processors configured to perform the method of any of Examples I1 to I7.

Example M1 includes a method comprising: receiving, by a user equipment (UE) of a network, discontinuous reception (DRX) configuration data from a base station of the network, wherein the DRX configuration data specifies one or more parameters for performing DRX by the UE; performing, by the UE, DRX in accordance with the DRX configuration data, wherein performing DRX comprises monitoring a Physical Downlink Control Channel (PDCCH) during one or more DRX ON durations determined based on the DRX configuration data; and obtaining, by the UE, one or more positioning reference signal (PRS) measurements during the one or more DRX ON durations.

Example N2 includes the method of Example N1. Further, the method comprises refraining from obtaining any PRS measurements during any DRX OFF durations.

Example N3 includes the method of Example N1. Further, the method comprises transmitting the one or more PRS measurements to a location management function (LMF) of the network.

Example N4 includes the method of Example N1. Further, the DRX configuration data comprises at least one of: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

Example N5 includes the method of Example N1. Further, the DRX configuration data specifies one or more parameters for performing DRX by the UE in a RRC_CONNECTED state.

Example N6 includes the method of Example N1. Further, the DRX configuration data specifies one or more parameters for performing Connected Mode DRX (C-DRX) by the UE.

Example 01 includes a user equipment (UE) comprising one or processors and one or more storage devices on which are stored instructions that are operable, when executed by the one or more processors, to cause the one or more processors to perform the method of any of Examples N1 to N6.

Example P1 includes a non-transitory computer storage medium encoded with instructions that, when executed by one or more processors, cause the one or more processors to perform the method of any of Examples N1 to N6.

Example Q1 includes an apparatus comprising one or more baseband processors configured to perform the method of any of Examples N1 to N6.

Example R1 includes a method comprising: transmitting, by a base station of a network, discontinuous reception (DRX) configuration data to a user equipment (UE) of the network, wherein the DRX configuration data specifies one or more parameters for performing DRX by the UE; and transmitting, by the base station, control information to the UE, wherein the control information comprises at least one of: an indication to obtain one or more positioning reference signal (PRS) measurements during a DRX ON duration, or an indication to refrain from obtaining any PRS measurements during a DRX OFF duration.

Example R2 includes the method of Example R1. Further, the control information is transmitted to the UE via Medium Access Control (MAC) signaling.

Example R3 includes the method of Example R1. Further, the control information is transmitted to the UE via Downlink Control Information (DCI) signaling.

Example R4 includes the method of Example R1. Further, the DRX configuration data comprises at least one of: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

Example R5 includes the method of Example R1. Further, the DRX configuration data specifies one or more parameters for performing DRX by the UE in a RRC_CONNECTED state.

Example R6 includes the method of Example R1. Further, the DRX configuration data specifies one or more parameters for performing Connected Mode DRX (C-DRX) by the UE.

Example S1 includes a base station comprising one or processors and one or more storage devices on which are stored instructions that are operable, when executed by the one or more processors, to cause the one or more processors to perform the method of any of Examples R1 to R6.

Example T1 includes a non-transitory computer storage medium encoded with instructions that, when executed by one or more processors, cause the one or more processors to perform the method of any of Examples R1 to R6.

Example U1 includes an apparatus comprising one or more baseband processors configured to perform the method of any of Examples R1 to R6.

Example V1 includes a method comprising: receiving, by a user equipment (UE) of a network, discontinuous reception (DRX) configuration data from a base station of the network, wherein the DRX configuration data specifies one or more parameters for performing DRX by the UE; performing DRX in accordance with the DRX configuration data, wherein performing DRX comprises monitoring a Physical Downlink Control Channel (PDCCH) during one or more DRX ON durations determined based on the DRX configuration data; receiving, by the UE, control information from the base station the UE, wherein the control information comprises at least one of: an indication to obtain one or more positioning reference signal (PRS) measurements during one or more DRX ON durations, or an indication to refrain from obtaining any PRS measurements during any DRX OFF durations; and obtaining, by the UE, one or more PRS measurements in accordance with the control information.

Example W2 includes the method of Example W1. Further, the method includes transmitting the one or more PRS measurements to a location management function (LMF) of the network.

Example W3 includes the method of Example W1. Further, the control information is received from the base station via Medium Access Control (MAC) signaling.

Example W4 includes the method of Example W1. Further, the control information is received from the base station via Downlink Control Information (DCI) signaling.

Example W5 includes the method of Example W1. Further, the DRX configuration data comprises at least one of: an information element representing a DRX ON duration timer with respect to the UE, an information element representing a DRX inactivity timer with respect to the UE, an information element representing a DRX slot offset with respect to the UE, an information element representing a short DRX cycle with respect to the UE, or an information element representing a long DRX cycle with respect to the UE.

Example W6 includes the method of Example W1. Further, the DRX configuration data specifies one or more parameters for performing DRX by the UE in a RRC_CONNECTED state.

Example W7 includes the method of Example W1. Further, the DRX configuration data specifies one or more parameters for performing Connected Mode DRX (C-DRX) by the UE.

Example X1 includes a user equipment (UE) comprising one or processors and one or more storage devices on which are stored instructions that are operable, when executed by the one or more processors, to cause the one or more processors to perform the method of any of Examples W1 to W7.

Example Y1 includes a non-transitory computer storage medium encoded with instructions that, when executed by one or more processors, cause the one or more processors to perform the method of any of Examples W1 to W7.

Example Z1 includes an apparatus comprising one or more baseband processors configured to perform the method of any of Examples W1 to W7.

Example AA1 includes a method comprising: transmitting, by a base station of a network, discontinuous reception (DRX) configuration data to one or more user equipment (UEs) in a wireless cell of the network, wherein the DRX configuration data specifies one or more parameters for performing paging DRX by the one or more UEs with respect to the wireless cell, and wherein the DRX configuration data is specific to the wireless cell; receiving, by the base station from a location management function (LMF) of the network, a request for the DRX configuration data; and transmitting, by the base station, the DRX configuration data to the LMF.

Example AA2 includes the method of Example AA1. Further, the request is included in a TRP INFORMATION REQUEST message transmitted to the base station by the LMF.

Example AA3 includes the method of Example AA1. Further, the DRX configuration data is included in at least one of a TRP POSITIONING INFORMATION RESPONSE message or a TRP POSITIONING INFORMATION UPDATE MESSAGE transmitted by the base station to the LMF.

Example AA4 includes the method of Example AA1. Further, the request signals the base station to transmit a single instance of the DRX configuration data to the LMF, and wherein transmitting the DRX configuration data to the LMF comprises transmitting the single instance of the DRX configuration data to the LMF.

Example AA5 includes the method of Example AA1. Further, the request signals the base station to transmit the DRX configuration data to the LMF periodically until receipt of a second request signaling the base station to discontinue providing the DRX configuration data to the LMF, and wherein transmitting the DRX configuration data to the LMF comprises transmitting the DRX configuration data to the LMF periodically until receipt of the second request.

Example AA6 includes the method of Example AA1. Further, the DRX configuration data comprises an information element representing a paging occasion configuration.

Example AA7 includes the method of Example AA1. Further, the DRX configuration data specifies one or more parameters for performing DRX by the one or more UEs in a RRC_INACTIVE or RRC_IDLE state.

Example BB1 includes a base station comprising one or processors and one or more storage devices on which are stored instructions that are operable, when executed by the one or more processors, to cause the one or more processors to perform the method of any of Example AA1 to AA7.

Example CC1 includes a non-transitory computer storage medium encoded with instructions that, when executed by one or more processors, cause the one or more processors to perform the method of any of Example AA1 to AA7.

Example DD1 includes an apparatus comprising one or more baseband processors configured to perform the method of any of Example AA1 to AA7.

Example EE1 includes a method comprising: receiving, by a user equipment (UE) in a wireless cell of a network, discontinuous reception (DRX) configuration data from a base station of the network, wherein the DRX configuration data specifies one or more parameters for performing paging DRX with respect to the wireless cell of the network, and wherein the DRX configuration data is specific to the wireless cell; receiving, by the UE, positioning reference signal (PRS) configuration data from a location management function (LMF) of the network, wherein the PRS configuration data specifies one or more parameters for obtaining one or more PRS measurements by the UE; performing, by the UE, DRX in accordance with the DRX configuration data, wherein performing DRX comprises monitoring a Physical Downlink Control Channel (PDCCH) during one or more DRX paging occasions determined based on the DRX configuration data; and obtaining, by the UE, one or more PRS measurements in accordance with the PRS configuration data, wherein obtaining the one or more PRS measurements in accordance with the PRS configuration data comprises obtaining the one or more PRS measurements during the one or more DRX paging occasions.

Example EE2 includes the method of Example EE1. Further, the method comprises refraining from obtaining any PRS measurements during any paging occasions.

Example EE3 includes the method of Example EE1. Further, the method comprises transmitting the one or more PRS measurements to the LMF.

Example EE4 includes the method of Example EE1. Further, the DRX configuration data comprises an information element representing a paging occasion configuration.

Example EE5 includes the method of Example EE1. Further, the DRX configuration data specifies one or more parameters for performing DRX by the UE in a RRC_INACTIVE or RRC_IDLE state.

Example FF1 includes a user equipment (UE) comprising one or processors and one or more storage devices on which are stored instructions that are operable, when executed by the one or more processors, to cause the one or more processors to perform the method of any of Examples EE1 to EE5.

Example GG1 includes a non-transitory computer storage medium encoded with instructions that, when executed by one or more processors, cause the one or more processors to perform the method of any of Examples EE1 to EE5.

Example HH1 includes an apparatus comprising one or more baseband processors configured to perform the method of any of Examples EE1 to EE5.

Example II1 includes a method comprising: receiving, by a location management function (LMF) of a network, discontinuous reception (DRX) configuration data regarding one or more user equipment (UEs) of the network, wherein the DRX configuration data specifies one or more parameters for performing DRX by the one or more UE.

Example II2 includes the method of Example II1. Further, the DRX configuration data comprises at least one of: an information element representing a DRX ON duration timer with respect to the one or more UE, an information element representing a DRX inactivity timer with respect to the one or more UEs, an information element representing a DRX slot offset with respect to the one or more UEs, an information element representing a short DRX cycle with respect to the one or more UEs, an information element representing a long DRX cycle with respect to the one or more UEs, or an information element representing a paging occasion configuration.

Example II3 includes the method of Example II1. Further, the method comprises generating, by the LMF, positioning reference signal (PRS) configuration data based on the DRX configuration data, wherein the PRS configuration data specifies one or more parameters for obtaining one or more PRS measurements by the one or more UEs.

Example II4 includes the method of Example II3. Further, the method comprises causing the PRS configuration data to be transmitted to the one or more UEs.

Example II5 includes the method of Example II4. Further, the method comprises receiving the one or more PRS measurements by the one or more UEs, and determining one or more locations of the one or more UEs based on the one or more PRS measurements.

Example II6 includes the method of Example II1. Further, at least a portion of the DRX configuration data is received from the base station.

Example II7 includes the method of Example II1. Further, at least a portion of the DRX configuration data is received from the one or more UE.

Example JJ1 includes a system comprising one or processors and one or more storage devices on which are stored instructions that are operable, when executed by the one or more processors, to cause the one or more processors to perform the method of any of Examples II1 to II7.

Example KK1 includes a non-transitory computer storage medium encoded with instructions that, when executed by one or more processors, cause the one or more processors to perform the method of any of Examples II1 to II7.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-85. (canceled)

86. A method comprising:
transmitting, by a base station of a network, discontinuous reception (DRX) configuration data to a user equipment (UE) of the network, wherein the DRX configuration data specifies one or more parameters for performing DRX by the UE;
receiving, by the base station from a location management function (LMF) of the network, a request for the DRX configuration data; and
transmitting, by the base station, the DRX configuration data to the LMF.

87. The method of claim 86, wherein the request is included in a POSITIONING INFORMATION REQUEST message transmitted to the base station by the LMF.

88. The method of claim 87, wherein the DRX configuration data is included in at least one of a POSITIONING INFORMATION RESPONSE message or a POSITIONING INFORMATION UPDATE MESSAGE transmitted by the base station to the LMF.

89. The method of claim 86, wherein the request signals the base station to transmit a single instance of the DRX configuration data to the LMF, and
wherein transmitting the DRX configuration data to the LMF comprises transmitting the single instance of the DRX configuration data to the LMF.

90. The method of claim 86, wherein the request signals the base station to transmit the DRX configuration data to the LMF periodically until receipt of a second request signaling the base station to discontinue providing the DRX configuration data to the LMF, and
wherein transmitting the DRX configuration data to the LMF comprises transmitting the DRX configuration data to the LMF periodically until receipt of the second request.

91. The method of claim 86, wherein the DRX configuration data comprises at least one of:
an information element representing a DRX ON duration timer with respect to the UE,
an information element representing a DRX inactivity timer with respect to the UE,
an information element representing a DRX slot offset with respect to the UE,
an information element representing a short DRX cycle with respect to the UE, or
an information element representing a long DRX cycle with respect to the UE.

92. The method of claim 86, wherein the DRX configuration data specifies one or more parameters for performing DRX by the UE in a RRC_CONNECTED state.

93. The method of claim 86, wherein the DRX configuration data specifies one or more parameters for performing Connected Mode DRX (C-DRX) by the UE.

94. An apparatus comprising one or more baseband processors configured to perform operations comprising:
transmitting, by a base station of a network, discontinuous reception (DRX) configuration data to a user equipment (UE) of the network, wherein the DRX configuration data specifies one or more parameters for performing DRX by the UE;
receiving, by the base station from a location management function (LMF) of the network, a request for the DRX configuration data; and
transmitting, by the base station, the DRX configuration data to the LMF.

95. The apparatus of claim 94, wherein the request is included in a POSITIONING INFORMATION REQUEST message transmitted to the base station by the LMF.

96. The apparatus of claim 95, wherein the DRX configuration data is included in at least one of a POSITIONING INFORMATION RESPONSE message or a POSITIONING INFORMATION UPDATE MESSAGE transmitted by the base station to the LMF.

97. The apparatus of claim 94, wherein the request signals the base station to transmit a single instance of the DRX configuration data to the LMF, and
wherein transmitting the DRX configuration data to the LMF comprises transmitting the single instance of the DRX configuration data to the LMF.

98. The apparatus of claim 94, wherein the request signals the base station to transmit the DRX configuration data to the LMF periodically until receipt of a second request signaling the base station to discontinue providing the DRX configuration data to the LMF, and wherein transmitting the DRX configuration data to the LMF comprises transmitting the DRX configuration data to the LMF periodically until receipt of the second request.

99. The apparatus of claim 94, wherein the DRX configuration data comprises at least one of:
an information element representing a DRX ON duration timer with respect to the UE,
an information element representing a DRX inactivity timer with respect to the UE,
an information element representing a DRX slot offset with respect to the UE,
an information element representing a short DRX cycle with respect to the UE, or
an information element representing a long DRX cycle with respect to the UE.

100. A method comprising:
receiving, by a user equipment (UE) of a network, discontinuous reception (DRX) configuration data from a base station of the network, wherein the DRX configuration data specifies one or more parameters for performing DRX by the UE;
receiving, by the UE, positioning reference signal (PRS) configuration data from a location management function (LMF) of the network, wherein the PRS configuration data specifies one or more parameters for obtaining one or more PRS measurements by the UE;
performing, by the UE, DRX in accordance with the DRX configuration data, wherein performing DRX comprises monitoring a Physical Downlink Control Channel (PDCCH) during one or more DRX ON durations determined based on the DRX configuration data; and
obtaining, by the UE, the one or more PRS measurements in accordance with the PRS configuration data, wherein obtaining the one or more PRS measurements in accordance with the PRS configuration data comprises obtaining the one or more PRS measurements during the one or more DRX ON durations.

101. The method of claim 100, further comprising refraining from obtaining any PRS measurements during any DRX OFF durations.

102. The method of claim 100, further comprising transmitting the one or more PRS measurements to the LMF.

103. The method of claim 100, wherein the DRX configuration data comprises at least one of:
an information element representing a DRX ON duration timer with respect to the UE,
an information element representing a DRX inactivity timer with respect to the UE,
an information element representing a DRX slot offset with respect to the UE,
an information element representing a short DRX cycle with respect to the UE, or
an information element representing a long DRX cycle with respect to the UE.

104. The method of claim 100, wherein the DRX configuration data specifies one or more parameters for performing DRX by the UE in a RRC_CONNECTED state.

105. The method of claim 100, wherein the DRX configuration data specifies one or more parameters for performing Connected Mode DRX (C-DRX) by the UE.
